(19) United States
(12) Patent Application Publication
(10) Pub. No.: US 2017/0057872 A1
(43) Pub. Date: Mar. 2, 2017

(54) Alkali-Activated Natural Aluminosilicate Materials for Compressed Masonry Products, and Associated Processes and Systems

(71) Applicant: Watershed Materials, LLC, Napa, CA (US)

(72) Inventors: David Carr Easton, Napa, CA (US); Jose F. Muñoz, Napa, CA (US); S. Taj Easton, Napa, CA (US); Khyber John Easton, Napa, CA (US)

(21) Appl. No.: 15/252,094

(22) Filed: Aug. 30, 2016

Related U.S. Application Data
(60) Provisional application No. 62/212,432, filed on Aug. 31, 2015.

(51) Int. Cl. C04B 28/00; B28B 3/02; C04B 40/00

(52) U.S. Cl. CPC C04B 28/006; C04B 40/0039; B28B 3/02; C04B 2111/00646

(57) ABSTRACT

Disclosed are masonry product feedstock compositions having natural aluminosilicate minerals, e.g., clay minerals and feldspars, to activate a geopolymer reaction. During the formation and curing of a masonry product, an alkali activator creates structural bonds within a mix of aggregates in the feedstock having a low moisture content (e.g., 5-10% by weight). The feedstock and manufacturing can require less energy, and can result in a lower environmental footprint than conventional masonry products. Associated processes and systems provide improved mixing and/or de-agglomeration of the feedstock, high compression during the formation of masonry products, and optimized curing. Exemplary products can include structural masonry units, veneer facing blocks, pavers, and other pre-cast products. Because the natural aluminosilicate minerals can be found in minimally processed abundant raw earth, the composition is not limited to conventional geopolymer materials that are sourced from industrial byproducts that are limited in geographic availability.

### CROSS REFERENCE TO RELATED APPLICATION

Thus application claims priority to U.S. Provisional Application No. 62/212,432, filed 31 Aug. 2015, which is incorporated herein in its entirety by this reference thereto.

### FIELD OF THE INVENTION

At least one embodiment of the present invention pertains to compositions for a feedstock to produce masonry products, and associated processes and systems, which use a geopolymer reaction to activate natural aluminosilicate minerals within the feedstock, wherein the natural aluminosilicate minerals include clay minerals and feldspars.

### BACKGROUND

Masonry is one of the most common construction materials globally. Tens of billions of ordinary concrete blocks are used on construction sites every year, to create durable, cost-effective buildings.

However, this durability comes at a high cost to the environment. Most masonry products, including conventional gray concrete blocks, are made by mixing sand and gravel together, with Portland cement. The worldwide use of Portland cement contributes significantly to greenhouse gas emissions, currently accounting for about 6 to 7 percent of all greenhouse gas emissions globally, due largely to the amount of energy required to produce it. In addition, the energy required to blast and crush virgin rock into gravel and sand, which are then used to make the blocks, further contributes to the carbon footprint that results from the extensive use of ordinary masonry materials. Therefore, the widespread use of concrete products for buildings is currently accelerating environmental decline.

Traditional geopolymer techniques require a reaction of silicas with an alkali activator to create structural bonds within a mix of aggregates, which provide an alternative to Portland cement based concrete. However, such existing geopolymer techniques rely on materials such as fly ash, metallurgical slags, pozzolanic materials, specific calcined-clays (metakaolin) and silica fume as a source of silicas for the geopolymer reaction. These materials are geographically limited, and can contain harmful heavy metals and other byproducts.

### BRIEF DESCRIPTION OF THE DRAWINGS

One or more embodiments of the present invention are illustrated by way of example and not limitation in the figures of the accompanying drawings, in which like references indicate similar elements.

FIG. 1 illustrates a system for manufacturing enhanced masonry products using a geopolymer reaction to activate natural aluminosilicate minerals, which include clay minerals and feldspars.

FIG. 2 is a schematic block diagram of an illustrative masonry formula that includes natural aluminosilicate minerals.

FIG. 3 is a flowchart of an exemplary process for manufacturing enhanced masonry products, including enhanced mixing and de-agglomeration of a moistened partially mixed formula that includes natural aluminosilicate minerals, and in situ formation of enhanced masonry blocks within a high-compression block press.

FIG. 4 illustrates a system for manufacturing enhanced masonry products, using a geopolymer reaction to activate natural aluminosilicate minerals within a feedstock having a low moisture content, wherein the system includes a primary mixer, secondary high-shear mixer for enhanced mixing and de-agglomeration of a moistened partially mixed formula, and a high compaction unit for in situ formation of enhanced masonry blocks.

FIG. 5 is a chart of an XRD diffractogram for an illustrative feedstock blend, which includes montmorillonite, alkali feldspar, and quartz.

FIG. 6 is a table that shows chemical and physical properties of soil blend and specific mineral additives.

FIG. 7 is a chart that shows particle size distribution of an illustrative SRSH3 blend.

FIG. 8 is a chart that shows size distribution of mineral additives measured using a laser particle size analyzer.

FIG. 9 is a table that shows mix proportions of alkoxides and silicon to aluminum ratio of synthetic nanoaluminosilicates in an illustrative feedstock.

FIG. 10 is a chart that shows an XRD diffractogram of nanoparticles for an illustrative feedstock.

FIG. 11A is a chart that shows a representative FTIR spectrum 800 of nanoaluminosilicate xerogels.

FIG. 11B is a chart that shows a shift in asymmetric stretching band as a function of the Si/Al ratio of the nanoaluminosilicate xerogels.

FIGS. 12A and 12B are charts that show the Influence of type of activator and its alkali to silica ratio on the strength of soil specimens with m=0.22 and w/g=0.5 (FIG. 12A) and the relationship between NaOH/NaSi activator content and compressive strength at 1 day and 7 days (FIG. 12B).

FIG. 13A is a chart that shows the effect of temperature on the compressive strength for an NaOH/NaSi activated feedstock.

FIG. 13B is a chart that shows the effect of curing time on the compressive strength for an NaOH/NaSi activated feedstock.

FIG. 14 is a chart that shows X-ray diffractograms of NaOH/SiNa activated soil blend with variable m values.

FIG. 15 is a chart that shows a detailed X-ray diffractogram of principal diffraction peaks of alkali feldspar between 27.0 and 28.5 2θ.

FIG. 16A and FIG. 16B are graphs that show effects on 1-day compressive strength (FIG. 16A) and 7-day compressive strength (FIG. 16B) of tested mineral additives. The soil specimens were stabilized using NaOH/NaSi with r=0.2, m=0.22 and w/g=0.5.

FIG. 17 is a graph that shows a correlation between silicon to aluminum ratio of the nanoparticle additives and compressive strength of soil specimens stabilized using NaOH/sodium silicate.

FIG. 18 is a chart that shows the influence of different nanoaluminosilicate additives on 1-day and 7-day compressive strength of test specimens.

FIG. 19 is a table that shows illustrative mix designs selected for microstructure characterization.

FIG. 20 is a table that shows illustrative linear drying shrinkage and microstructural characterization data for optimized mix designs.

FIG. 21 is a graph showing measured differences in cumulative porosity for optimized mix designs.

FIG. 22 is a high level block diagram showing an illustrative processing device that can be a part of any of the systems herein.

### DETAILED DESCRIPTION

References in this description to “an embodiment”, “one embodiment”, or the like, mean that the particular feature, function, structure or characteristic being described is included in at least one embodiment of the present invention. Occurrences of such phrases in this specification do not necessarily all refer to the same embodiment. On the other hand, the embodiments referred to also are not necessarily mutually exclusive.

Introduced here are feedstock mixtures, systems, structures, processes, and other technologies that enable the fabrication of enhanced masonry products.

In certain embodiments, a feedstock composition uses a geopolymer reaction to activate natural aluminosilicate minerals, which include clay minerals and feldspars. During the formation and curing of a geopolymer masonry product, an alkali activator reacts with silica to create a structural bond, which can also bind together a mix of aggregates in the feedstock, which can have a low moisture content (e.g., 5-10% by weight). The feedstock and associated manufacturing can require less total energy, and can result in a lower environmental footprint than a wide range of conventional masonry products. Associated processes and systems provide improved mixing and/or de-agglomeration of the feedstock, high compression during the formation of masonry products, and optimized curing. Exemplary products can include structural masonry units similar to concrete masonry units (CMUs/cinder blocks), veneer facing blocks, pavers, and other pre-cast products. Because the source of silicas for the geopolymer reaction is natural aluminosilicate minerals, which can be found in minimally processed abundant raw earth, the composition is not limited to conventional geopolymer materials that are sourced from industrial byproducts that are limited in geographic availability.

In certain embodiments, secondary mixing and/or de-agglomeration of the feedstock is accomplished with a deagglomerator that includes a vertical shaft high-shear mixer, wherein a rotational force (hydraulic or electric) is mounted to a vertical shaft onto which are mounted chains and/or knives, housed within a flexible rubber “boot” or tube. The deagglomerator is configured to be controllably powered, to rotate the shaft and the attached tools. Partially mixed feedstock, i.e., formula, is introduced to a top region of the deagglomerator, and falls downwardly past the rotating tools wherein the formula is pulverized and mixed, before exiting the lower area of the mixing region as a product formula.

In some embodiments, a block mold includes a plurality of mold elements, such as a lower impact plate, an upper impact plate, and a plurality of side plates, and can further include one or more block cores. In some embodiments, one or more of the mold elements can be moved to dynamically form a block mold, which is then filled with product formula. The product formula is then compressed, to form a masonry block. One or more of the mold elements are then released, such as to release pressure on the formed masonry block, and to allow removal of the formed masonry block from the block press, wherein the formed masonry block can be moved to a curing area, and the block press can reform the block mold for subsequent production.

In certain embodiments, a process introduced here involves the following sequence of actions, as described more fully below. A masonry feedstock or formula is premixed to include a desired blend of constituents. The masonry formula is further processed, through a high-shear mixer, which can act as a de-agglomerator, such as to break down the constituents and improve the homogeneity of the mixture, thus producing a product formula. A high-compression block press, which in some embodiments can comprise a dynamic block press, receives the product formula and fills a dynamically formed mold, such as with a predetermined weight of the product formula. The high-compression block press compresses the product formula to form a masonry block (also called a “masonry unit” or “masonry product’), and then releases the dynamically formed mold, whereby the formed masonry block can be removed from the high-compression block press. The masonry units are then cured, which can be optimized for the feedstock, the mixing, and the high-compression molding.

In some embodiments, the feedstock mixtures and associated systems and processes are configured to produce masonry products without Portland cement using geopolymer reactions that activate natural aluminosilicate minerals. The masonry products can include structural masonry units that are otherwise similar to concrete masonry units (CMUs/cinder blocks), veneer facing blocks, pavers, or other pre-cast products.

These products are typically manufactured today using traditional concrete techniques, with Portland cement as the binder within a mix of aggregates including washed sand and gravel. However, Portland cement is the most expensive and environmentally destructive ingredient in traditional concrete masonry.

In contrast to such conventional techniques, the feedstock mixtures and associated systems and processes disclosed herein utilize geopolymer reactions, together with mixing technology, ultra-high compression, and a controlled curing regimen to provide the strength in place of Portland cement.

Geopolymer technology involves a reaction of silicas with an alkali activator to create structural bonds within a mix of aggregates. The end result of a material made using geopolymer technology is similar to the end result of a material made using Portland cement technology, however the input materials are different and geopolymer technology typically involves less total energy and has a lower environmental footprint.

Other forms of geopolymer technology exist in the market that also provide an alternative to Portland cement based concrete. However, existing geopolymer technology relies on materials such as fly ash, metallurgical slags, pozzolanic materials, specific calcined-clays (metakaolin) and silica fume as the source of silicas for the geopolymer reaction. These materials are geographically limited and can contain harmful heavy metals and other byproducts.

In contrast to conventional geopolymer techniques, the feedstock mixtures and associated systems and processes disclosed herein do not rely on traditional sources of silica, but instead use natural aluminosilicate minerals found readily all over the world as the reactive source of silicas for the geopolymer reaction.

No other entities currently known to the inventors are currently exploring geopolymer technology using natural aluminosilicate minerals as the source of silicas, because these minerals are comparatively less reactive in the geopolymer reaction than other more reactive sources of silicas including fly ash, metakaolin, and silica fume.

The feedstock mixtures and associated systems and processes disclosed herein are able to create a geopolymer reaction, with this less reactive source of silicas, such as by carefully selecting materials for the mix design formulation, by employing novel material mixing technology, by utilizing a high compression manufacturing process, and by applying novel technology in the curing of the masonry products. One or more of these elements of the production workflow can be implemented to produce durable masonry products without Portland cement, using geopolymer reactions that activate natural aluminosilicate minerals.

The feedstock mixtures and associated systems and processes disclosed herein are unique from existing Portland cement based concrete and masonry. Currently the market offers a vast array of masonry products manufactured using conventional Portland cement technology and geopolymer technology. The geopolymer feedstock mixtures and associated systems and processes disclosed herein are different from traditional concrete technology in that they do not rely on Portland cement for strength. Additionally, technology disclosed herein allows for the use of unwashed, non-premium aggregates, which are unable to be used in traditional concrete mix designs, particularly aggregates with high contents of clay sized particles and aggregates containing expansive clay minerals.

The geopolymer feedstock mixtures and associated systems and processes disclosed herein are also unique compared to other geopolymer techniques in the market in several ways. Most notably, the source of silicas for the geopolymer reaction disclosed herein is natural aluminosilicate minerals found in abundant raw earth. Most other forms of commercially produced geopolymers use fly ash, metakaolin, or silica fume as the source of silicas for the geopolymer reaction. While some of these materials are found in nature, others are byproducts of industrial processes, and all require refining and are limited in geographic availability.

In contrast, the geopolymer technology disclosed herein unlocks the possibility of activating a geopolymer reaction using minimally processed abundant raw earth.

Earth construction has a long history, predating even Roman concrete construction. Recently earth construction has been improved through the use of Portland cement as a stabilizer. Stabilized rammed earth (SRE) blocks and compressed earth blocks (CEB) are widely used around the world as an ecological and economic alternatives to cast in place concrete and concrete masonry units (CMU). SRE blocks and CEBs do not use any form of geopolymerization. Rather, they use Portland cement and compaction to achieve strength.

WATERSHED BLOCK™ are low carbon masonry blocks, which are currently available through Watershed Materials, LLC, of Napa Calif., can utilize similar aggregate sources to that of SRE and CEBs, but differ in the degree of precision applied to selecting the aggregate and their constituent components, and only use about 50% of the cement content of traditional CMUs, and do not currently use any form of geopolymer technology.

Some embodiments of the geopolymer technologies disclosed herein can use similar aggregate sources to that of WATERSHED BLOCK™, such as unwashed aggregates that can contain certain clays. In some embodiments, the processes disclosed herein place strict limitations on the maximum allowable percentage of natural aluminosilicate minerals in the formulation. Additionally, gradation of the coarser aggregate fraction is engineered to produce the optimum packing density, such as using the Fuller index.

As well, the processes disclosed herein apply a far greater compactive effort during the molding phase than either SRE or CEB, resulting in increased grain-to-grain contact, and thus drastically improving ultimate compressive strength and product durability.

Many examples of machines exist for making CEBs, but the compressed earth blocks they produce are of low quality and/or require high levels of Portland cement to provide strength.

There are no examples currently known to the inventors of companies or other entities that are working on geopolymer masonry block formulations or machines, using natural aluminosilicate minerals found in abundant raw earth as the source of silicas for the geopolymer reaction.

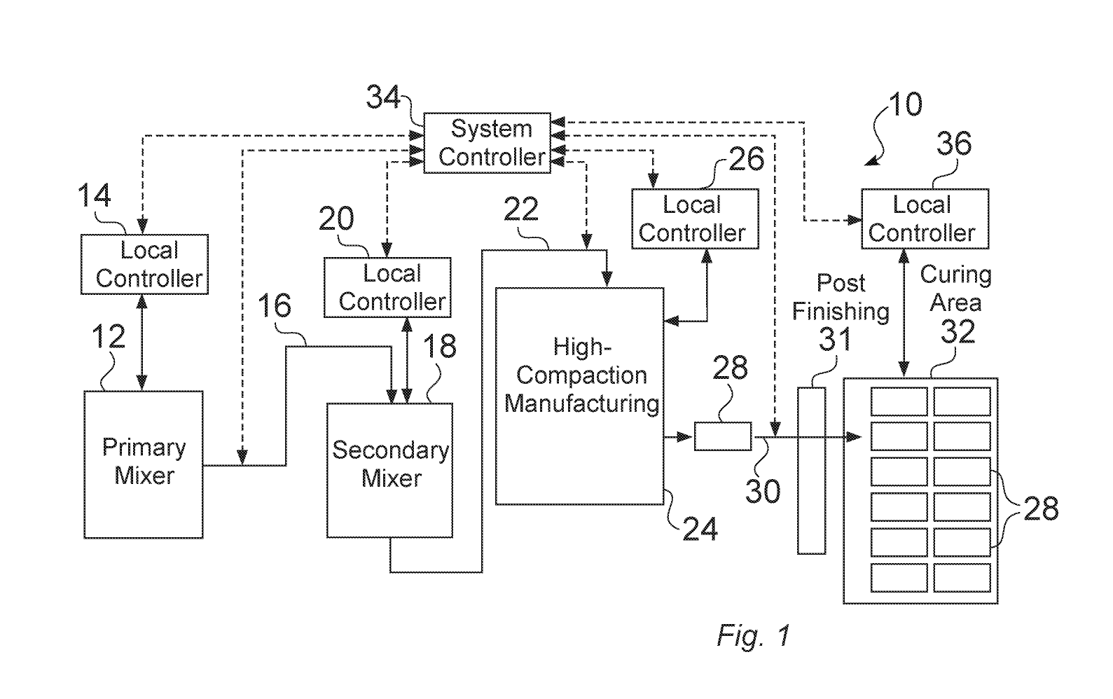

FIG. 1 illustrates a system 10 for manufacturing enhanced masonry products 28, including a high-shear mixer 18 for enhanced mixing and de-agglomeration of a moistened partially mixed formula, and a high-compression block press 24 that is configured to form enhanced masonry blocks 28. In some embodiments, the high-compression block press 24 comprises a dynamic block press 24.

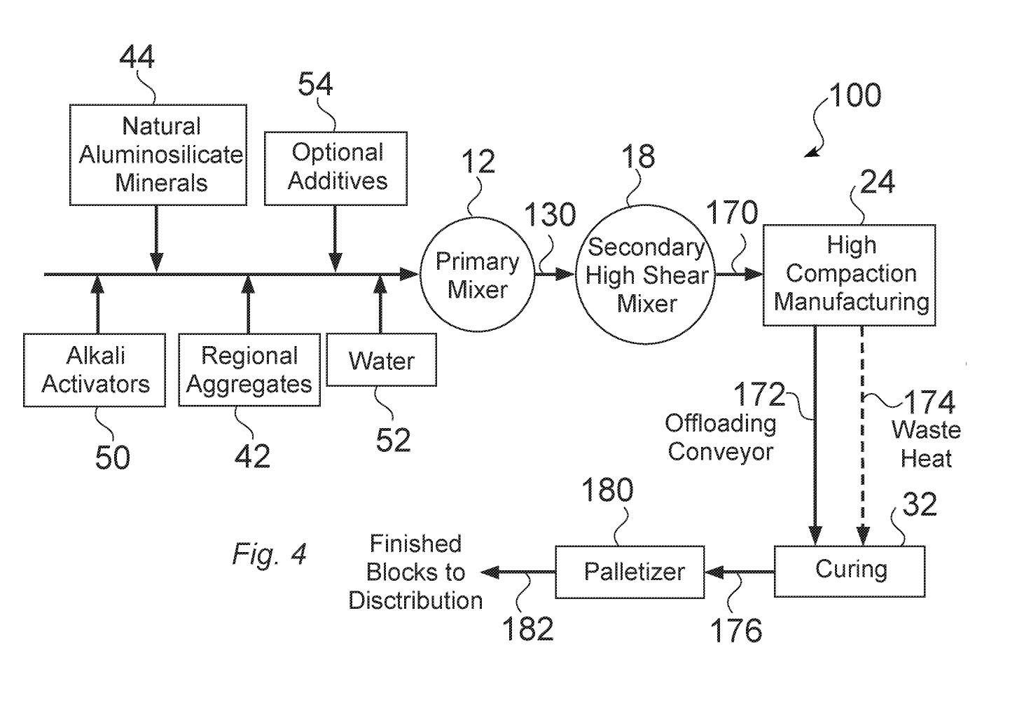

As seen in FIG. 1, a primary mixer 12 can be used to premix a desired masonry formula 130 (FIG. 4), wherein the mixer 12 can be operated either manually, by a local controller 14, by a system controller 34, or by any combination thereof. Water is also added to the masonry formula during the premixing, such as to achieve a predetermined moisture content for the manufacture of the enhanced masonry blocks 28.

The pre-moistened and mixed masonry formula 130 is transferred 16 to the secondary mixer 18, which can be configured for any of further mixing, pulverizing or otherwise breaking down constituents, and/or de-agglomerating the pre-moistened formula 130. The enhanced processing of the pre-moistened formula 130 produces a product formula 170 (FIG. 4), which is significantly more homogenous than the initial pre-moistened formula 130, and substantially improves the resultant quality of the enhanced masonry blocks 28. The secondary mixer 18 can be operated either manually, by a local controller 20, by the system controller 34, or by any combination thereof.

As also seen in FIG. 1, the product formula 170 is transferred 22 to the high-compression block press 24, wherein the product formula 170 is controllably loaded into a dynamically formed block mold, to produce one or more enhanced masonry blocks 28. The high-compression block press 24 can be operated either manually, by a local controller 26, by the system controller 34, or by any combination thereof.

The enhanced masonry blocks 28 are removed from the high-compression block press 28, and can be transferred 30 to a curing area 32, such as a curing rack 32, pallets 28 or a similar structure. The curing area 32 can be operated either manually, by a local controller 34, by the system controller 36, or by any combination thereof.

In some embodiments, one or more post-production finishing operations 1402, e.g., 1402a-1402g, can be provided for the enhanced masonry blocks 28, such as at a post-production finishing area 31 which can include one or more stations, before the enhanced masonry blocks 28 are moved to the curing area 32.

In some embodiments, the curing area 32 can control one or more environmental factors, such as temperature and/or humidity. As will be described in greater detail below, the constituents and moisture content of the enhanced masonry blocks can be significantly different than conventional concrete blocks, thus producing blocks that can readily be removed from the high-compression block press 24 and handled, after formation.

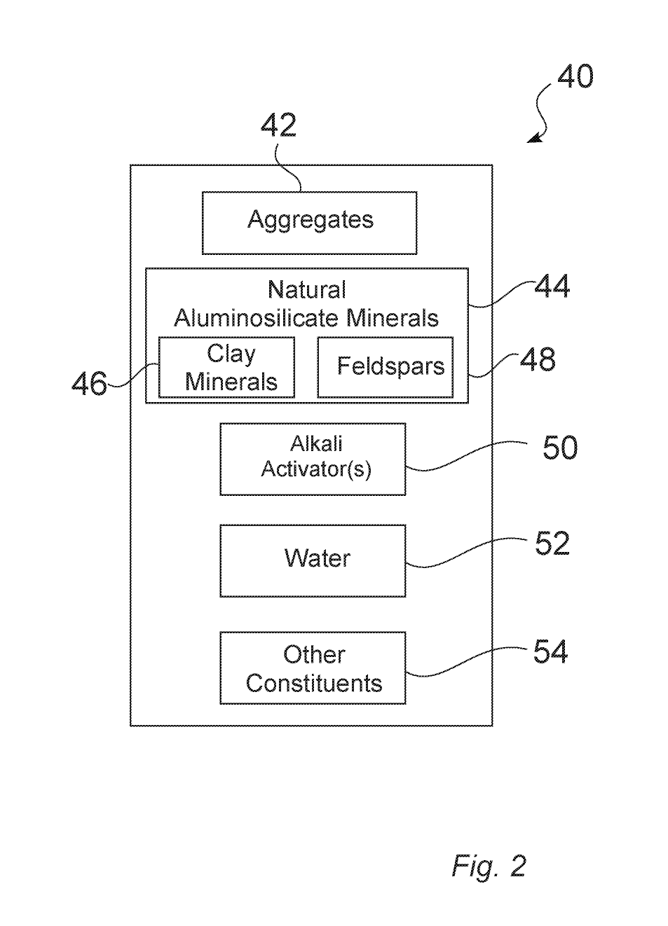

FIG. 2 is a schematic block diagram 40 of illustrative constituents that can be included in some embodiments of the enhanced masonry formula 130 (FIG. 4). The secondary mixer 18 and/or high-compression block press 24 can be used for a wide variety of masonry formulas, and can readily be adapted for available local materials. The illustrative formula 130 seen in FIG. 2 can comprise any of aggregate 42, natural aluminosilicate materials 44 (e.g., clay minerals 46 and feldspars 48), one or more alkali activators 50, and water 52, and can further comprise other constituents 54, such as any of hydrated lime, supplementary cementitious materials (SCMs), water repelling additives, nano-seeding additives, or any combination thereof.

Some embodiments of the enhanced masonry formula 130 have a moisture content of less than or equal to 12 percent, e.g., 6 to 12 weight percent, or less than 12 percent by weight, e.g., 6 to 11.75 weight percent water. Some current embodiments of the enhanced masonry formula 130 have a moisture content of 5 to 10 weight percent water.

When properly activated, and followed by high compression, the enhanced masonry formula 130 can produce a wide variety of high strength and durable enhanced masonry units 28, such as geopolymer masonry units 28.

In some embodiments, the aggregates 42 can include any of soils, by-products of aggregate productions, mill tailings, granular recycled products, and commercially produced aggregates.

In some embodiments, the supplementary cementitious materials can include any of hydraulic cements, fly ash, metallurgic slags, silica fume, metakaolin, and rice husk ash.

In some embodiments, in addition to water 52, other constituents 54 can include chemical admixtures, and their combinations.

In some embodiments, constituents 54 can include nano-additives, such as any of amorphous silica and boehmite, zeolitic precursors, and precipitates such as calcium silica hydrate (C-S-H) and calcium aluminum silica hydrate (C-A-S-H).

In some embodiments, the mixture proportions of the masonry formula 130 are calculated to produce enhanced masonry blocks 28 for a specific product or application. In an illustrative embodiment, for aggregates 42 and alkali activated mixtures 44,50, the mix proportions can be determined by the Fuller equation: P=100 (d/D)ⁿ, where P is the proportion of grains of a given diameter, d is the diameter of grains for a given value of P, D is the largest grain diameter, and n is the grading coefficient. The proportions are calculated based on n values ranging from 0.45 to 0.75. In some embodiments, nano-additives can be added in the range of 1 to 10 percent by binder mass. As well, in some embodiments, the alkali activated mixture 44,50 is determined according to the MA_{200 W} index value, calculated as PI*(% mass/100), where PI is the plasticity index of the aggregate mixture, and % mass is the percentage of the total aggregate passing sieve 200 collected by wet sieving. In some embodiments, the total water content 52 of the masonry formula 130 is calculated as the sum of the optimal moisture content of the aggregate 42 and the water 52 necessary for chemical reaction of the alkali activated mixture 44,50.

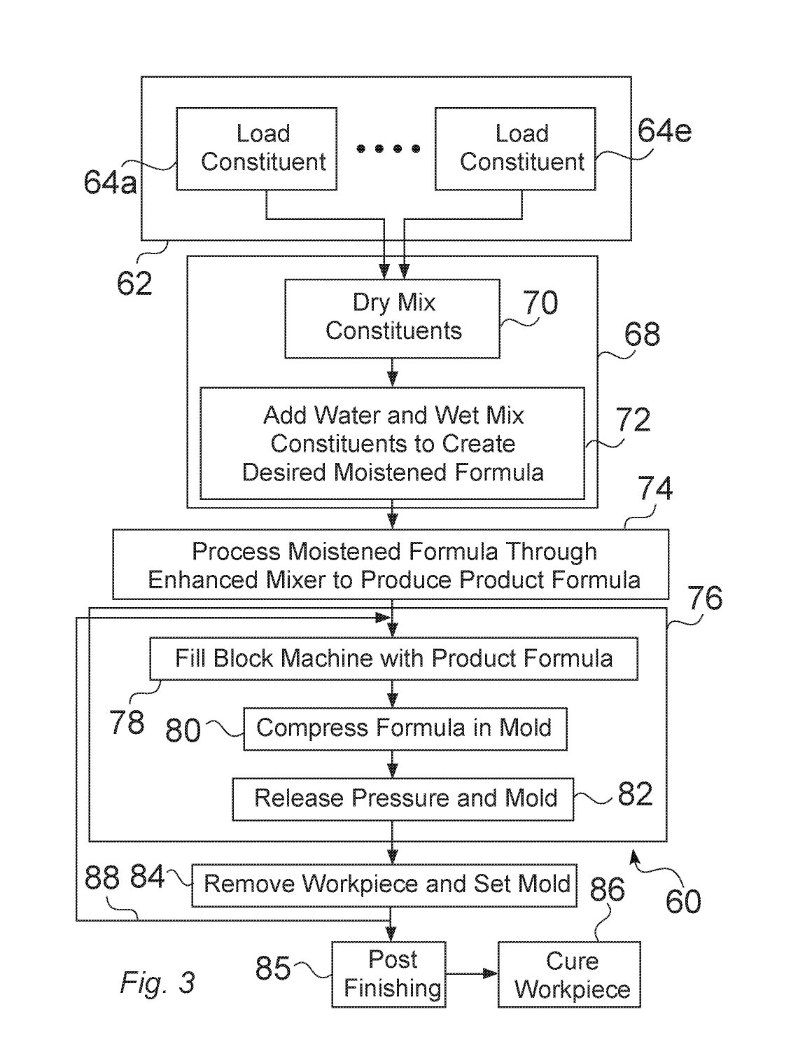

In some embodiments, the composition of the masonry formula 130 can be chosen based on the intended compression, e.g., 80 (FIG. 3), and can also be chosen based on the high-compression manufacturing process 24,76 used to form the masonry blocks, pavers, or other products 28. In some embodiments, the applied compression, i.e., compaction effort, can range from 1500 to 2500 pounds of force per square inch of unit face.

In some embodiments, the level of applied compression or compaction can be based on a predetermined threshold, such as based on any of density, volume, reduction of voids, the moistened partially mixed formula 130,170, or any combination thereof. For example, for a moistened partially mixed formula 130,170 which has previously been used to produce masonry blocks 28 having known qualities when compressed to a known level of compression, this information can provide a predetermined threshold for subsequent production. Furthermore, such a predetermined threshold can be modified, such as based on any of available feedstock constituents, water content, agglomeration level, or a desired performance characteristic of the masonry blocks 28.

In some embodiments of the block press high-compression manufacturing process 24,76, consolidation can accomplished through static forces, dynamic forces, or any combination thereof. The impact component of a dynamically applied force can be measured in blows per minute. In masonry units 28 with depths greater than 4″, for some masonry formulas 130, high-compression can be applied in multiple lifts, such as to achieve 98% density for a desired finished height dimension 1046 (FIG. 35).

FIG. 3 is a flowchart of an illustrative process 60 for manufacturing enhanced masonry products 28, such as using a high-shear mixer 18 for processing a moistened partially mixed formula 130 to produce a product formula 170, and a high-compression manufacturing process 24,76 for forming enhanced masonry blocks 28 within a block mold.

As seen in FIG. 3, the preparation of a masonry formula 130 can be initiated 62 by loading a first constituent mixture, such as including mineral fines 44, and a second constituent mixture, such as including binder or cement 46, in a primary mixing apparatus 12. A desired ratio of the constituents 108 can be mixed 68, such as by dry mixing 70 the constituents 108 together, and then producing a moistened masonry formula 130, such as by introduction 72 of water 52 and wet mixing the resultant formula 130.

While conventional mixing methods can be used to produce a pre-moistening masonry formula 130, such as for use in the production of enhanced masonry products 28, there are often shortcomings encountered with such conventional mixtures, such as incomplete mixing of all the constituents, inconsistent or large sizes of aggregates, and/or the formation of agglomerations, sometimes referred to as pilling, within the pre-moistened masonry formula 130, which can reduce the homogeneity of the resultant masonry formula 130.

Therefore, as seen in the illustrative process 60, the pre-moistened formula 130 can be processed 74 through a secondary mixer 18, wherein the pre-moistened formula 130 can come into contact with high-speed mixing tools, thereby breaking down aggregates 42 and agglomerations, and further mixing the constituents to produce a desired product formula 170.

As further seen in FIG. 3, the product formula 170 can readily be used to form 76 enhanced masonry products 28, e.g., blocks 28. A block mold that is dynamically formed within the high-compression block press 24 is filled 78 with product formula 170, which in some embodiments comprises a predetermined weight of product formula 170. In some embodiments, the predetermined weight can be calculated, determined, or adjusted, to produce a masonry block 28 of known dimensions, such as for a given product formula 170, having a known moisture content, and for a specified compression 80, to form a masonry block 28.

In some embodiments, once the block mold is filled 78, the product formula 170 within the block mold is compressed 80, and then the pressure is released 82, as one or more portions of the block mold are retracted. As also seen in FIG. 3, in some embodiments, the formed masonry unit 28 can be removed 84 from the high-compression block press 24, and the block mold can be dynamically reformed 80, whereby the high-compression block press 24 can be used to produce a subsequent masonry unit 28. The formed and removed masonry unit 28 can then typically be transferred 30 (FIG. 1) to a curing area 32, e.g., a curing rack 32, where the formed masonry unit 28 can be allowed to cure, such as for up to 30 days.

FIG. 4 illustrates a system 100 for manufacturing enhanced masonry products 28, using a geopolymer reaction to activate natural aluminosilicate minerals 44 within a feedstock 130, 170 having a low moisture content, wherein the system 100 includes a primary mixer 12, a secondary high-shear mixer 18 for enhanced mixing and de-agglomeration of a moistened partially mixed formula 130,170, and a high compaction unit 24 for in situ formation of enhanced masonry blocks 28. The system and process of mix design formulation, material mixing technology, the high compaction manufacturing process, and curing process, as disclosed herein, are unique and critical elements to Watershed Materials' geopolymer technology.

The illustrative feedstock 40 seen in FIG. 4 includes regional aggregates (e.g., 50-75% by weight), natural aluminosilicate materials (e.g., 15-35% by weight), one or more alkali activators 50 (e.g., 3-5% by weight of sodium silicate and/or sodium hydroxide), and water (e.g., 5-10% by weight). The feedstock 40 can also include one or more optional additives 54 (e.g., hydrated lime, SCMs, stearates, water repelling additives, and/or nano-seeding additives).

The illustrative system 100 seen in FIG. 4 can be configured to premix 68 and moisten a masonry formula 130 for the manufacture of enhanced masonry products 28. While some embodiments of the primary mixer 12 can be configured for the mixing conventional concrete or gunite formulas, other embodiments of the pre-mixing apparatus 18 can specifically be configured for pre-mixing of the constituents of an enhanced masonry formula 130.

The illustrative primary mixer 12 seen in FIG. 1 and FIG. 4 can include a constituent hopper assembly that feeds into a pre-mixing assembly. The hopper assembly can include a hopper having one or more hopper sections, which can be configured to receive and controllably output constituent mixtures toward a common chute.

Each of the constituent mixtures can include one or more constituents, such as including any of aggregates 42, natural aluminosilicate materials 44 (e.g., clay minerals 46 and feldspars 48), one or more alkali activators 50, and water 52, and can further comprise other constituents 54, such as any of hydrated lime, supplementary cementitious materials (SCMs), water repelling additives, nano-seeding additives, or any combination thereof. For example, in a hopper having two hopper sections, a first constituent mixture can comprise a predetermined mixture of one or more aggregates 42, while a second constituent mixture can comprise a predetermined mixture of natural aluminosilicate materials 44, one or more alkali activators 50, and other constituents 54.

The illustrative primary mixer 12 seen in FIG. 1 and FIG. 4 can also include a delivery mechanism for each of the hopper sections, such as including a controllable gate for each of the delivery mechanisms, which can be controlled manually, by a local controller 14 (FIG. 1), or by a system controller 34 (FIG. 1), whereby the resultant formula 130 includes a controlled ratio of the desired constituents.

Once the constituents are initially mixed together, such as within a chute region, they can be advanced through the entrance of the pre-mixing assembly 12, which can extend through a dry mixing region and a wet mixing region, toward an exit. The primary mixer seen in FIG. 4 can include a lower trough that generally defines a lower half of a cylindrical conduit, and an upper cover that generally defines an upper half of the cylindrical conduit. An auger can extend longitudinally through the primary mixer 12, which can be configured to rotate, to promote mixing of the constituents as they move toward the exit. The primary mixer 12 can also include a water delivery assembly for the controlled introduction of water 52, which is additionally mixed with the other constituents in the wet mixing region, to form the pre-moistened masonry formula 130, which can then be transferred 16 to the secondary mixer 18.

Mix Design Formulation.

Some illustrative embodiments of Watershed Materials' geopolymer technology can utilize mix designs containing:

natural aluminosilicate minerals (15-35% by weight);

regional aggregates (50-75% by weight);

sodium silicate and sodium hydroxide alkali activators (3-5% by weight); and

a low molding moisture (5-10% by weight).

In some embodiments, fine particles containing natural aluminosilicate minerals are incorporated into the mix design, which can be evaluated prior to formulation to determine any of mineralogy, plasticity, particle size distribution, and potential to contribute to geopolymerization.

In some embodiments, aggregates that are incorporated into the mix design are evaluated prior to formulation, to determine any of mineralogy, aggregate density, and potential to contribute to a dense and durable matrix.

Input aggregate and soil materials can be separated by particle size and recombined in optimized formulations (following the Fuller Index) to enhance achievement of close inter-particle contact under compression, resulting in enhanced performance.

In some embodiments, the incorporation of various additives in the mix design can yield benefits to the performance of finished products. For example:
the incorporation of hydrated lime (5-10% by weight) can yield improvements to strength, durability and shrinkage;
the incorporation of certain supplemental cementitious materials (e.g., metakaolin, ground granulated blast furnace slag) can yield improvements to strength, durability and shrinkage;
the incorporation of stearates (0.25-1.5% by weight) yields improvements in water absorption and corresponding properties;
the incorporation of water repelling additives developed for the concrete industry yields improvements in water absorption and corresponding properties; and/or
the incorporation of additives to promote nano-seeding of the geopolymerization reaction can yield improvements to strength and other properties.

Mixing.

In some embodiments, the geopolymer technology and associated processes and systems incorporates high-shear mixing, which can be applied as a secondary mixing process 18, after the primary low shear mixing process 12. The high shear mixing technology 18 can be integral to successful geopolymerization of natural aluminosilicate minerals found in abundant raw earth.

When small particles of aluminosilicates are blended with water, there is the tendency within the primary low shear mixing process 12 for the particles to form small agglomerations, especially in the case of clay minerals. These pea-sized pellets inhibit dispersion of the fine particles of clay with the alkali activators 50 within the material feedstock mix 130, which can otherwise reduce the effectiveness of the geopolymer reaction, and reduce the development of final strength.

Therefore, embodiments of the geopolymer technology disclosed herein can incorporate a secondary high-shear mixer 18 that breaks apart these agglomerations, which can improve dispersal of the resultant geopolymer feedstock composition 170. Laboratory testing has demonstrated compressive strength gains of up to 50% when secondary high-shear mixing 18 is incorporated into the production process 100.

Manufacturing.

The high compression manufacturing process 24,76 disclosed herein can be critical for the ultimate strength, durability, and overall quality of the masonry products 28 produced with the disclosed geopolymer technology. The high compression manufacturing process 76 and associated system 24 can increase the contact points between the elements of the mix design, also known as grain-to-grain contact, and reduce pore space within the final product.

Laboratory testing has demonstrated dramatic strength gains when ultra-high compressive forces are incorporated into the manufacturing process 76. Calibrated testing has documented that a density of increase of only 2% can increase strength by up to 50%, and reduce absorptivity by up to 20%, yielding corresponding benefits to durability.

Curing.

The curing process 86 and associated system 32 disclosed herein can have a profound effect of the ultimate strength, durability, and overall quality of the masonry products 28 produced with geopolymer feedstock 130,170 disclosed herein.

Curing of products 28 formed 76 from the geopolymer feedstock 170 disclosed herein generally involves three steps:

dissolution of aluminosilicates through interaction with alkali materials;

condensation of precursor ions into monomers; and

polycondensation or polymerization of monomers into polymeric structures.

These processes occur relatively quickly, and the optimization of particular environmental variables of the curing regime in the first 72 hours after production can significantly impact the performance of the final product.

In some embodiments, the curing 32,86 can apply to one or more of the following curing conditions to achieve optimal strength, durability, and overall quality of the masonry products produced with the geopolymer technology disclosed herein:

curing temperatures of 60-95 C;

curing humidities of 80-95%; and

curing times of 24-72 hr.

Alkali-Activated Natural Aluminosilicate Minerals for Compressed Masonry Construction Feedstocks.

This portion of the disclosure describes research that was performed in regard to some specific embodiments of the geopolymer technology disclosed herein. For example, while the research describes the use of potassium hydroxide as an activator, the geopolymer technology disclosed herein is not limited to the use of potassium hydroxide as an activator. As well, while the research describes nano-seeding with nano-aluminosilicates, the geopolymer technology disclosed herein is not limited to such nano-seeding. As such, while this portion of the disclosure describes specific research which was performed, the geopolymer technology disclosed herein is not limited to the research as outlined herein.

As disclosed herein, aluminosilicate minerals can be activated with one or more alkali activators to produce strong masonry materials. In some embodiments, the alkali reaction is nucleated with nano-aluminosilicates. In an illustrative embodiment, 0.25 wt. % of nano-aluminosilicate rendered up to an 80% increase in compressive strength.

In some embodiments, alkali can be used activate aluminosilicate minerals which are reclaimed from recycled quarried soil products, to produce compressed masonry construction materials. Research was performed to identify and optimize the principal variables affecting geopolymerization of a common quarry by-product containing montmorillonite and alkali feldspars and other minerals. The key variables optimized in the research were: type and concentration of alkali activator, optimum moisture content for compaction and geopolymerization, and curing temperature and duration.

Geopolymerization of natural aluminosilicate minerals exhibiting low reactivity typically require supplementary cementitious materials to achieve high strength. In this case, however, the use of supplementary cementitious materials was eliminated by promoting nucleation in the geopolymerization reaction. The addition of 4 wt. % of nanocalcite or 0.25 wt. % of synthetic nanoaluminosilicates significantly improved the 1-day and 7-day compressive strengths of test specimens. Finally, the total porosity and pore-size distribution of the microstructure of certain specimens were characterized. The results were correlated with water absorption and drying shrinkage performance. The results demonstrate the feasibility of alkali activating commonly-occurring, natural aluminosilicates in the soils to produce compressed masonry blocks that exhibit reliable mechanical performance without the use of Portland cement or supplemental cementitious materials.

Ordinary Portland cement (OPC) has been proven to be a highly effective binder with the capability to improve the mechanical properties and durability of compressed-earth masonry materials. However, the production and use of OPC is associated with significant CO₂ emissions and environmental concerns. The production of each metric ton of OPC results in roughly 900 kg of CO₂ released into the atmosphere, and studies have shown that worldwide production of cement causes 6-7% of global greenhouse gas emissions. The leading method for reducing the environmental impacts associated with cement stabilization is to replace a portion of OPC binders with supplementary cementitious materials (SCMs). This class of materials, which includes fly ash, silica fume, metakaolin, and natural pozzolans contribute to the development of desirable mechanical properties through hydraulic or pozzolanic activity. In practice, the most commonly used SCMs are industrial by-products such as fly ash and ground granulated blast furnace slag, owing to their widespread availability and lower cost compared with cement. When added to concrete mixes, these materials have been demonstrated to reduce the need for OPC binders, reducing greenhouse gas emissions and, in some cases, enhancing long-term strength, durability and other mechanical properties.

Despite the widespread use of fly ash and other SCMs, recent research questions the environmental benefits of SCMs, suggesting they are at best a partial solution to reducing the environmental impacts associated with concrete. The main handicap of using SCMs as replacement is their inadequate supply in proximity to the greatest demand of OPC. In 2010, the annual global demand of cement was close to 3300 million tons, while the global combined production of fly ash, iron and steel slag, and silica fume was only 750 million tons. Fly ash accounts for approximately 80% of the production of all SCMs. Life cycle analysis shows that transporting fly ash more than fifty miles from its origin dramatically increases its environmental impacts, and reduces its economic viability as a cement replacement. This analysis shows that fly ash and other combustion co-products must be produced in proximity to cement production sites to ensure their economic and environmental viability as sustainable cement substitutes. In the case of the United States, fly ash availability around the country follows the same pattern as the distribution of coal-fired plants from which it is derived, resulting in dramatically uneven geographical availability. For example, in the North and South East Central regions and the West North Central region, fly ash production exceeds cement demand; by contrast, other regions such as the Northeast and West Coast produce insufficient amounts of fly ash to keep up with demand, limiting its use as a viable cement replacement in these areas. Finally, as fly ash is transformed from a liability to a valuable by-product, it could effectively subsidize coal-fired electricity generation, which is currently responsible for 20% of the world's total GHG emissions. For the reasons demonstrated above, the incorporation of conventional SCMs into concrete is at best a partial solution to reducing the environmental impacts associated with OPC, and in some cases can even have the opposite effect.

A different method for reducing the environmental impact of masonry materials is to use the geopolymerization of aluminosilicates to replace energy intensive OPC binders. In contrast to the incremental environmental gains offered by conventional SCMs, geopolymerization incorporating nanoadditives is environmentally sustainable and is capable of radically transforming conventional OPC masonry on a global scale. The aluminosilicates necessary for geopolymerization occur naturally in the clays found in many common soils. Therefore, some embodiments promote geopolymerization of aluminosilicates in compacted soils, in place of washed aggregates and OPC. Soil is an ubiquitous and almost unlimited resource that promises the possibility of truly sustainable cradle-to-cradle life-cycle performance.

Geopolymerization has been studied for over a half of a century, owing to its potential to provide a viable alternative to OPC-stabilized concrete. The geopolymerization reaction involves four principal stages:
a) the dissolution of aluminosilicate minerals triggered by alkali hydroxide;
b) the diffusion of silica and alumina complexes into the pore space;
c) the condensation of large, three-dimensional amorphous aluminum- and siliconoxide polymers which act as effective nuclei for further polymerization; and
d) the hardening of the newly-formed gel phase.

Extensive literature exists concerning the principal factors affecting the alkali activation of kaolin and metakaolin, supplementary cementitious materials and, to a lesser extent, feldspars and zeolite-type minerals to produce geopolymer concrete.

By contrast, little information is available about the stabilization of commonly-occurring soils with geopolymers, in either uncompressed or compressed soil systems.

Therefore, research was conducted to explore the possibility of producing high-quality, geopolymer-stabilized compressed soil materials by alkali activation of commonly-occurring, natural aluminosilicate minerals found in post-industrial recycled, quarried soil products—principally phyllosilicates and feldspars. The principal objectives of the research were to determine the effect of the following key factors on microstructure and strength of geopolymer samples:
Type and concentration of alkali activator, including the SiO₂ to M₂O molar ratio;
Optimal molding water content;
Optimal curing temperature, length and regime; and
Optimal conditions for promoting nano-seeding in natural and synthetic nanoaluminosilicate minerals.

Materials and Methods.

Soil Blend.

Two fine aggregate materials were selected to create the soil mix design primarily used in this study:

a by-product from a rhyolitic rock crushing operation (SR); and

a clayey fine aggregate (SH).

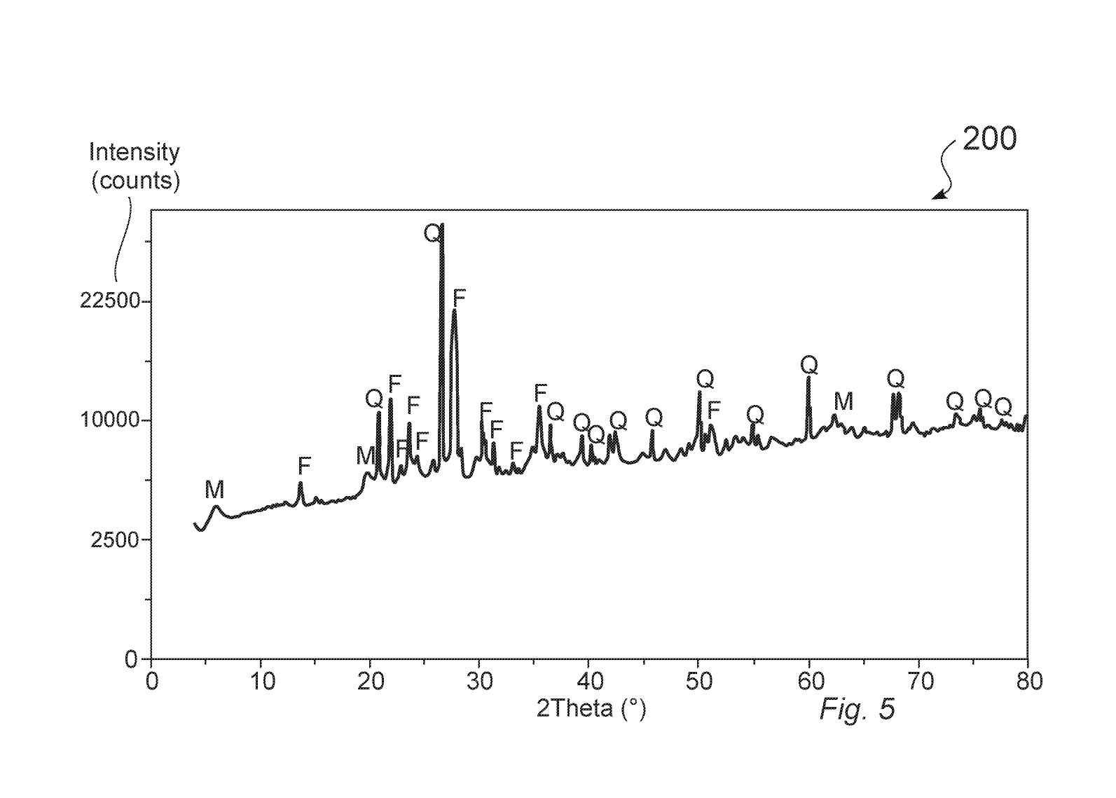

FIG. 5 is an XRD diffractogram of an illustrative SRSH3 blend, where principal peaks are label as M: montmorillonite, F: alkali feldspar and Q: quartz. The mineral composition of the resulting aggregate blend (SRSH3), containing 78% SR and 22% SH by total dry weight, was determined by X-ray diffraction (XRD). A complete XRD diffractogram of the SRSH3 blend is displayed in FIG. 5, in which montmorillonite, alkali feldspar, and quartz were the principal minerals. This soil blend was chosen as a baseline for these experiments based on the presence of the necessary aluminosilicate minerals and because it was representative of mix designs which could be easily reproduced throughout the country (and abroad) using commonly-occurring, post-industrial recycled quarry by-products.

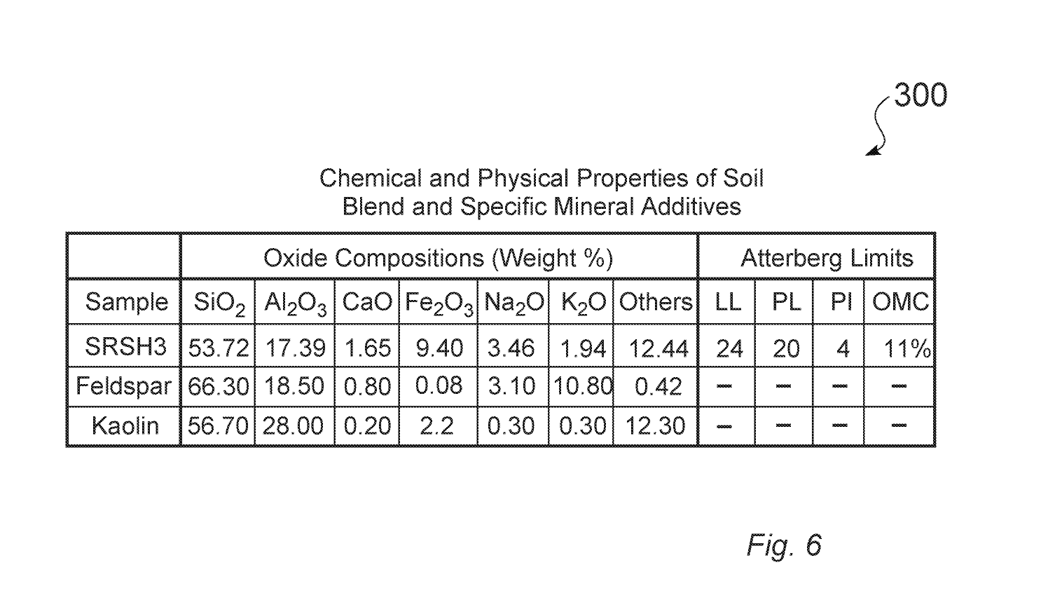

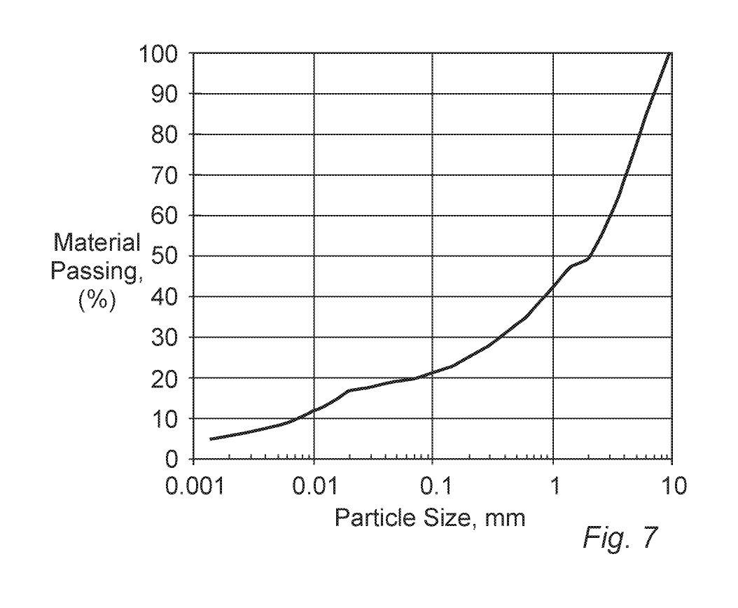

FIG. 6 is a table 300 that shows chemical and physical properties of soil blend and specific mineral additives. FIG. 7 is a graph 400 that shows particle size distribution of an illustrative SRSH3 blend. The particle-size distribution, Atterberg limits, and optimum moisture content (OMC) of the mix design can be determined following ASTM standards D422-63(2007)e1, D4318-10e1 and D558-11, respectively. A summary of the physical characteristics of the SRSH3 soil blend is shown in FIG. 6 and FIG. 7.

Alkali Activators.

Three different reagent grade chemicals from Sigma Aldrich were tested to determine their effectiveness as alkali activators in promoting geopolymerization in the SRSH3 mix design:

sodium hydroxide (NaOH);

potassium hydroxide (KOH); and

sodium silicate (NaSi).

The chemical composition of the NaSi was 10.6% NaO₂ and 26.5% SiO₂ by total weight, as reported by the manufacturer. The mix proportions used were obtained by carefully controlling the following ratios:
SiO₂ to M₂O molar ratio of the activator (r), where M is an alkali atom (K+ or Na+);
moles of alkali per 100 g of fines (m), where the fines are defined as the amount of soil passing the #100 sieve (particles<150 μm); and
water to geopolymer ratio (w/g), in which geopolymer is defined as the total amount of fines and alkali activator.

It was assumed that particles not passing the #100 sieve (>150 μm) would not contribute significantly to the geopolymerization reaction, due to their low specific surface. However, it is expected that the crystalline silica particles presented in the microfine particles smaller than 150 μm would not contribute directly to the geopolymerization reaction.

Mineral Additives.

Five different minerals were tested to evaluate their effect on nucleation in the geopolymerization reaction, corresponding to stage “c” described above:
calcium carbonate;
feldspar;
2:1 phyllosilicate (bentonite); and
1:1 phyllosilicates (kaolin and halloysite).

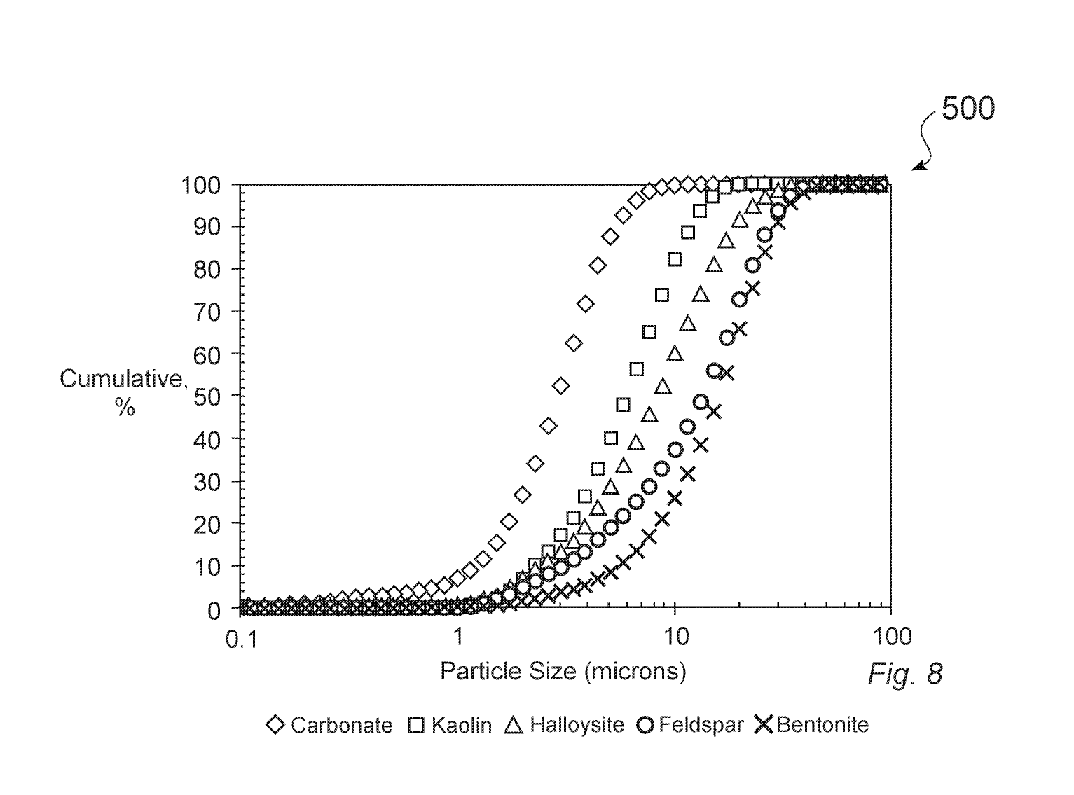

The calcium carbonate product used for testing was Betocarb 3, available through Omya, Inc. of Cincinnati, Ohio. The potassium-sodium-calcium feldspar product used for testing was G-200 Feldspar, available through Digitalfire Corp., of Medicine Hat, Alberta, Canada. The nanohydrophilic Bentonite (H₂Al₂O₆Si) and the nanohalloysite (H₄Al₂O₉Si₂ 2H₂O) used for testing were supplied by Sigma Aldrich Co, LLC, of St. Louis, Mo. The Kaolin Greenstripe clay used for testing was supplied by lone Minerals Inc., of lone, CA. The oxide compositions of the feldspar and the Kaolin are shown in FIG. 8.

FIG. 5 is a chart 200 of an XRD diffractogram for an illustrative feedstock blend 130, which includes montmorillonite, alkali feldspar, and quartz. Even though some of the materials are characterized as nanoparticle additives, the particle-size distribution measurements obtained through laser diffraction spectrometry, such as presented in FIG. 5, indicate a high degree of agglomeration. Thus, when initially added to the soil system, the additives are not typically fully dispersed, wherein their nucleation capacity can initially be significantly diminished.

Mineral additives were tested at mix proportions ranging from a minimum of 0.2 wt. % to a maximum of 5.0 wt. %. The promotion of a full dispersion of all these additives, in particular both nanoclays, can enhance their effects on the geopolymer-stabilized samples. However, current practices (such as sonication, high shear or acoustic mixing) to achieve full dispersion of this type of nano-additives are energy intensive. Therefore, to maintain the low embodied energy profile of the geopolymer-stabilized samples, some initial testing did not include a greater dispersion of the tested nano-additives.

Nanoaluminosilicates.

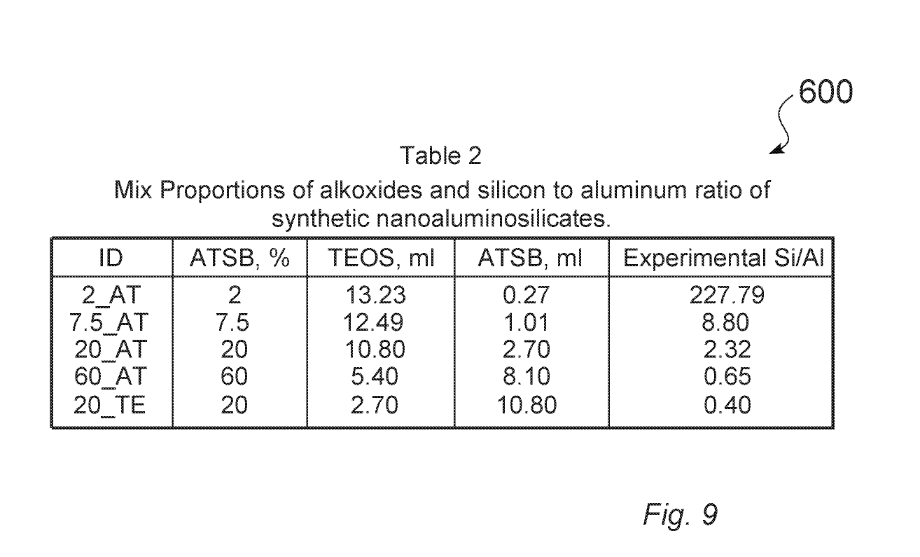

FIG. 9 is a table 600 that shows mix proportions of alkoxides and silicon to aluminum ratio of synthetic nanoaluminosilicates in an illustrative feedstock 130. A total of five nanoaluminosilicates with controlled silicon to aluminum ratios were synthesized following standard sol-gel processes. The synthesis protocol used was a variation from the method described in Pozarnsky and McCormick, where the silica precursor was allowed to “prehydrolyze” in water at pH 3 for a period of 10 minutes at room temperature. After this prehydolysis step, the aluminum precursor, previously homogenously dissolved in 10 ml of sec-butyl alcohol, was added and stirred until complete homogenization. The following reagent grade chemicals were used in the preparation of the sols: aluminum-tri-sec-butoxide (ATSB), tetra-ethyl orthosilicate (TEOS), sec-butyl alcohol (C₄H₁₀O), nitric acid (HNO₃), ammonium hydroxide (NH₄OH) and deionized water. The aluminosilicates were synthesized by mixing different proportions of TEOS and ATSB with 90 ml of deionized water previously acidified to pH 3 with nitric acid. The proportions of TEOS and ATSB used in these experiments are seen in the table 600 shown in FIG. 9. This synthesis protocol was reported to produce amorphous nano-aluminosilicates with particle sizes ranging from 25 to 340 nm.

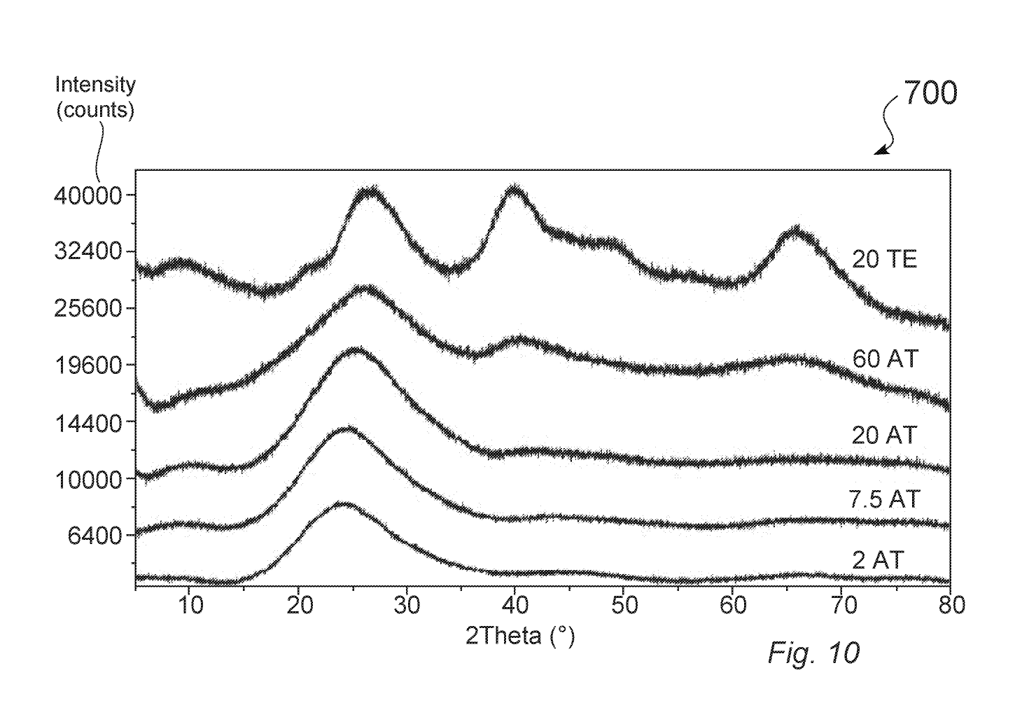

FIG. 10 is a chart 700 that shows an XRD diffractogram of nanoparticles for an illustrative feedstock 130. The XRD data shown in FIG. 10 illustrates the amorphous nature of the resulting nanoparticles. As the aluminum content in the nanoparticle increased, the amorphous hump of silica at 24 2θ shifted toward higher 2θ values. At high contents of alumina (20_TE) the diffractogram revealed a transition toward a boehmite structure.

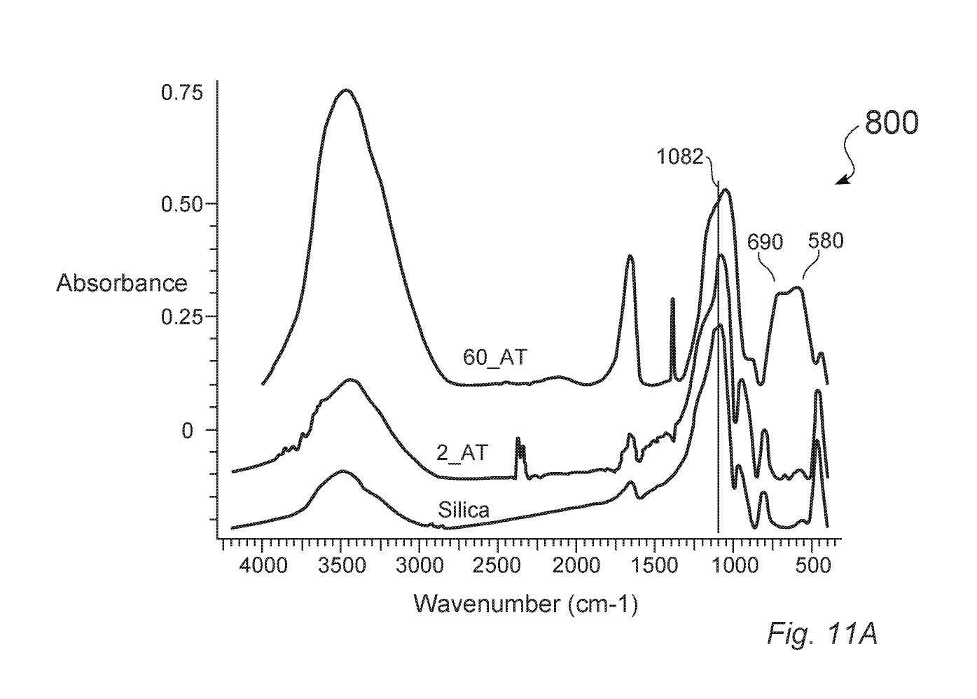

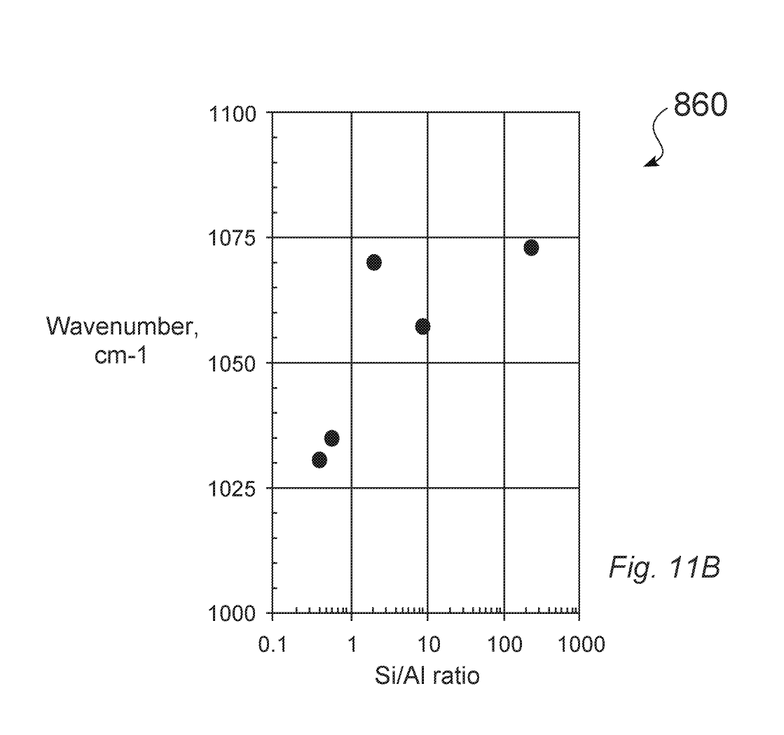

FIG. 11A shows a representative FTIR spectrum 800 of nanoaluminosilicate xerogels. FIG. 11B is a chart 860 that shows a shift in asymmetric stretching band as a function of the Si/Al ratio of the nanoaluminosilicate xerogels. The 690 and 580 cm⁻¹ bands are associated with Al—O stretching vibrations of condensed octahedral AlO₆. The FTIR data in FIG. 11A and FIG. 11B also proves the incorporation of the aluminum in the silica framework. The characteristic vibrational band of amorphous silica at 1082 cm⁻¹ associated with Si—O—Si asymmetric stretching shifts toward lower wavelength numbers as a consequence of the Si—O—Al bond formation. As is shown in FIG. 11A, the shift is proportional to the amount of aluminum diffused into the silica framework.

Experimental Methods.

An Empyrean Series 2 X-ray Diffraction System manufactured by Panalytical was used to study the mineralogy of the soil blend, the xerogels, and the progress of the geopolymerization in the alkali-activated soil samples. The X-ray source was a Cu anode operating at 45 kV and 40 mA. Data was collected between 5 degrees C. and 70 degrees C. in 2θ with a step of 0.0131 degrees C. and scan step time of 200 seconds per step. The nanoparticles, as xerogels, were analyzed using a Digilab Excalibur FTS 3000 Series Fourier transform infrared spectrometer. The spectra of KBr pellets with 0.3% sample concentration were collected at 4 cm⁻¹ resolution and co-adding 32 scans per spectrum.

The suitability of this alkali-activated soil blend as a potential material to manufacture soil masonry material was initially evaluated by testing of compressed cylinders of 101.6 mm length and 152.4 mm of diameter. All test specimens were manufactured under compression using a custom fabricated hydraulic press operated at a constant pressure (14.5 MPa), moisture (11%), and mass (2100 g). Following compaction, the specimens were cured under sealed conditions. A temperature of 65 degrees C. and length of 7 days were selected as main curing conditions. The final molding water content was maintained at 11%, equal to the OMC determined for the unstabilized mix design (including no alkali activators), as it was assumed that the alkali activators did not affect the OMC. This assumption was reinforced by the fact that adding additional water above the 11% significantly reduced the compressive strength of the alkali activated specimens. The corresponding measurements showed that an increase in the molding moisture content of 2% above the established OMC of the alkali-activated soil blend resulted in a 34% reduction in compressive strength.

Following curing under sealed conditions, the specimens were unwrapped and subjected to compression testing according to the ASTM standards D1633-00(2007). A period of 20 min was allowed for the specimens to reach room temperature. Compressive strength values were adjusted using correction factors ranging from 0.85 to 0.91 based on the aspect ratio of test specimens. The value was proposed based on correction factors reported in the ASTM C42 and related bibliography. Water absorption of test specimens was measured according to ASTM standards C140/140M-14, respectively. Linear drying shrinkage was measured following ASTM standard C426-10. Capillary water absorption, desorption isotherms, and freeze-thaw durability were measured following ASTM standards C1585-13, C1498-04a (2010)e1, and C1262-10, respectively. The pore size structure of specimens was quantified following methodologies described in relevant peer-reviewed literature. A minimum of three samples was tested for all the reported measurements for statistical analysis. The error bars were used in each graph to illustrate the standard deviation for each set of measurements. These bars were only visible in those cases that the measurements rendered coefficients of variation above 2%.

Overview of Principal Variables Controlling the Geopolymerization of Alkali Activated Soil.

The initial set of experiments was designed to quantify the influence of key variables influencing the geopolymerization of natural aluminosilicate minerals in compressed SRSH3 specimens, including:

type and concentration of the alkali activator; and

temperature and duration of curing regimen.

1-day, 3-day, 7-day and 28-day compressive strengths were used as indicators of the progress of the geopolymer reaction.

Effect of Alkali Activators.

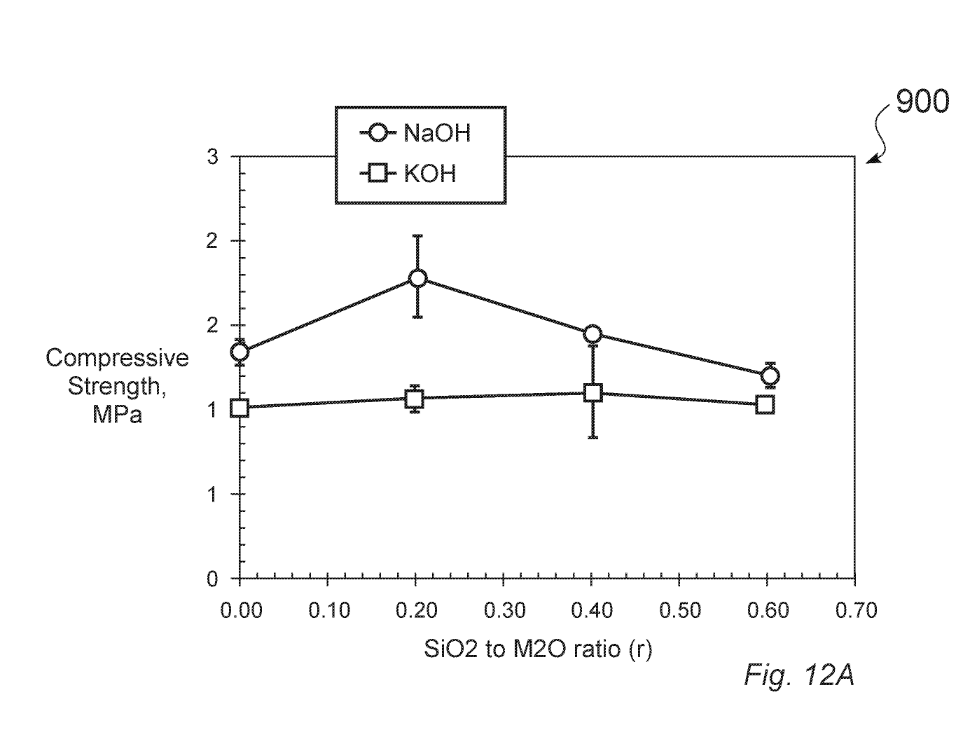

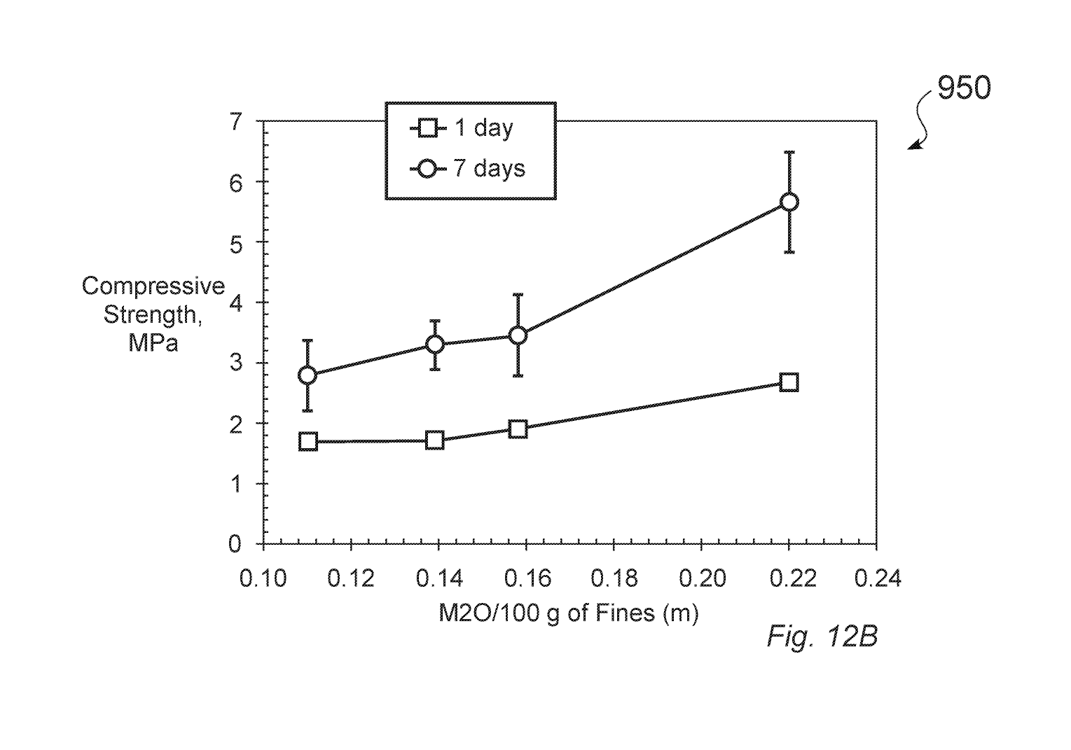

The reaction of clay minerals and feldspars in the soil, as measured by compressive strength development, was optimized through testing of two principal alkali activators: NaOH and KOH, mixed with various proportions of NaSi. FIG. 12A and FIG. 12B illustrate the effects of the type of alkali hydroxide (NaOH or KOH), silica content of the activator (r), and concentration of the activator (m) on the 1- and 7-day compressive strengths of test specimens. Specimens activated with NaOH rendered higher compressive strengths than those activated with KOH. The optimal r-value for the NaOH and NaSi activator blend was 0.2. The quantity of activator was shown to have a significant impact on the compressive strength, especially after 7 days of curing; the m value selected for testing for the NaOH and NaSi activator blend was found to be 0.22. Compressive strength continued to increase at the highest concentration of the activator (m) tested, as shown in FIG. 12B, indicating the possibility of achieving higher compressive strength values at m values above 0.22; however, some leaching of alkalis was detected in specimens stabilized with m values above this threshold.

Effect of Temperature and Duration of the Curing Process.

Alkali activators are not the only factor affecting geopolymerization of compressed aluminosilicate materials. Because temperature and duration of the curing regime also play a role in geopolymerization, a set of experiments was designed to evaluate the influence of these key variables.

The temperature and the duration of the curing regime strongly influences the formation of the amorphous aluminosilicate network. Curing at high temperatures (ranging from 40 to 80 degrees C.) has beneficial effects on the strength of the gel phase, causing an increase in the overall compressive strength. The length of the curing period, especially at temperatures above 80 degrees C., also greatly influences strength development. Longer curing times are in some cases beneficial, though prolonged curing at temperatures above 80 degrees C. can have a negative influence on strength development. Therefore, it is important to balance the temperature and length of the curing regime in order to achieve optimal mechanical performance.

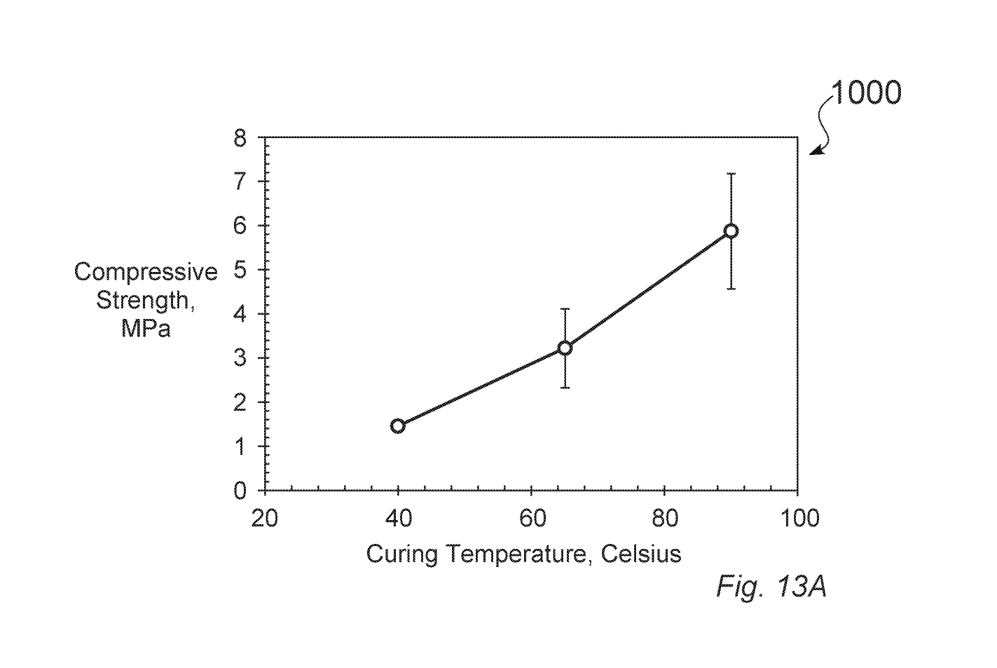

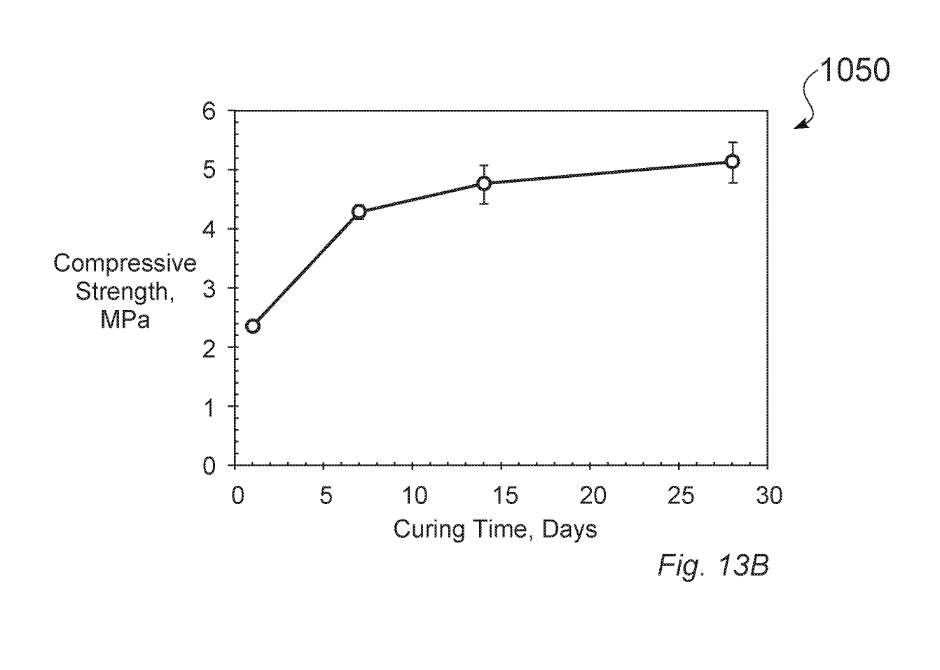

FIGS. 13A and 13B are charts that show principal factors controlling the strengthening of the newly formed gel phase: effect of temperature (FIG. 13A) and length (FIG. 13B) of curing regime for NaOH/NaSi activated soils with r=0.2, m=0.22 and w/g=0.5. As is illustrated in FIG. 13A and FIG. 13B, the temperature and duration of the curing regime was shown to have a significant impact on compressive strength development. Increasing the curing temperature from 40 degrees C. to 90 degrees C. resulted in an increase in the 1-day compressive strength of test specimens by 300%. The duration of the elevated temperature curing regime also had a significant effect on compressive strength; on average, compressive strength was increased by 102% between 1 day and 7 days. By 7 days of curing at 65 degrees C., specimens developed 80% of their 28-days compressive strength. Despite the fact that the highest compressive strengths (13.1 MPa) in these experiments were reached at curing temperatures of 90 degrees C., 65 degrees C. was established as the curing temperature for further testing. This decision was informed by the assumption that a lower curing temperature would improve the economy and reduce the embodied energy of the resulting products, as curing has been shown to be a significant energy requirement in the production of conventional concrete blocks.

Based on these results, the geopolymerization conditions adopted for further testing were:
an alkali activator blend of NaOH and NaSi, having an r-value of 0.2;
an m-value of 0.22;
a molding moisture content of 11%; and
a curing regime of 7 days at 65 degrees C.

Effect of Alkali Activators on the Mineralogy of the Soil Blend.

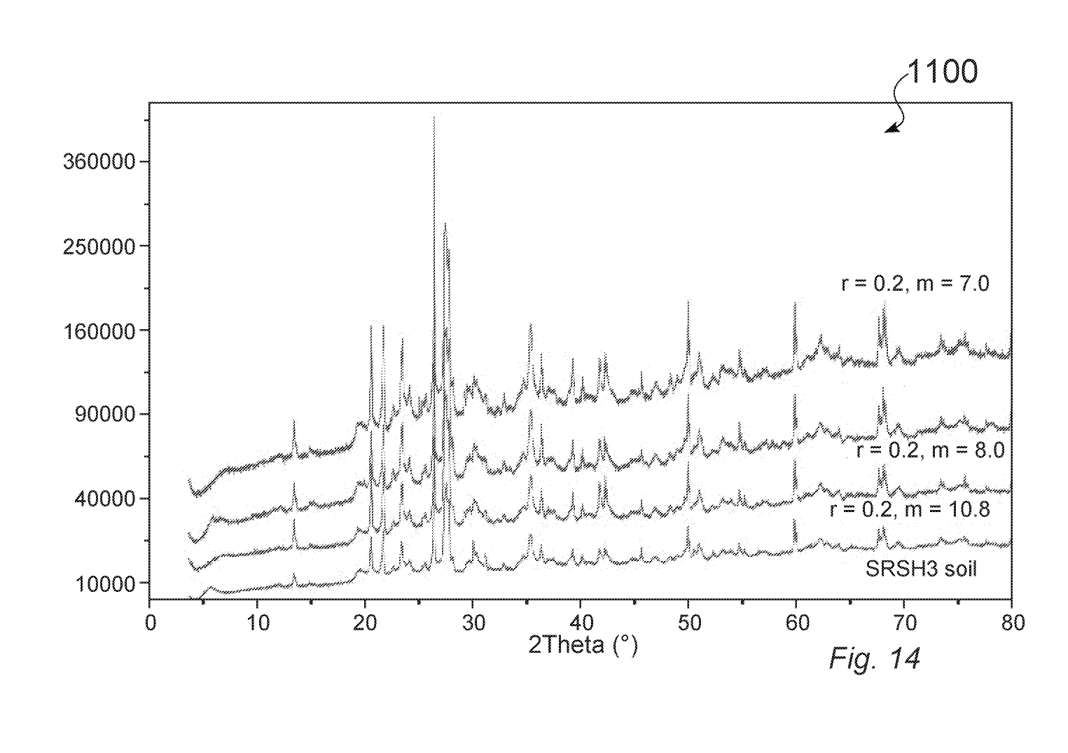

FIG. 14 is a chart 1100 that shows X-ray diffractograms of NaOH/SiNa activated soil blend with variable m values. A deeper understanding of the alkali activation of natural occurring aluminosilicates in the SRSH3 blend was obtained through XRD analysis of specimens activated with NaOH and NaSi, at a constant r value of 0.2 and different m values. The diffractograms of a total of 3 specimens were collected to determine the primary aluminosilicates minerals in the soils being dissolved, and also to identify the formation of new mineral phases formed during the geopolymerization reaction. As is shown in FIG. 14, in each of the three cases, the main diffraction peak at 5.76 2θ of the montmorillonite disappeared. Assuming limited solubility of the clay minerals at basic pH levels, the disappearance of the peak was most likely caused by an exfoliation process undergone by the clay mineral. The traditional stacking along the Z-axis of the basic structural unit of the montmorillonite (two silica tetrahedral sheets and one alumina octahedral) was disrupted by the alkali activator. The exfoliation of the clay caused a reduction in its cation exchange capacity. As a result, the liquid limit of the montmorillonite clay decreased, causing a reduction in the plasticity index. These results were supported by Atterberg limits test results; reductions in the plasticity index of the SRSH3 soil blend to zero were observed after 24 hours under the alkaline conditions described above.

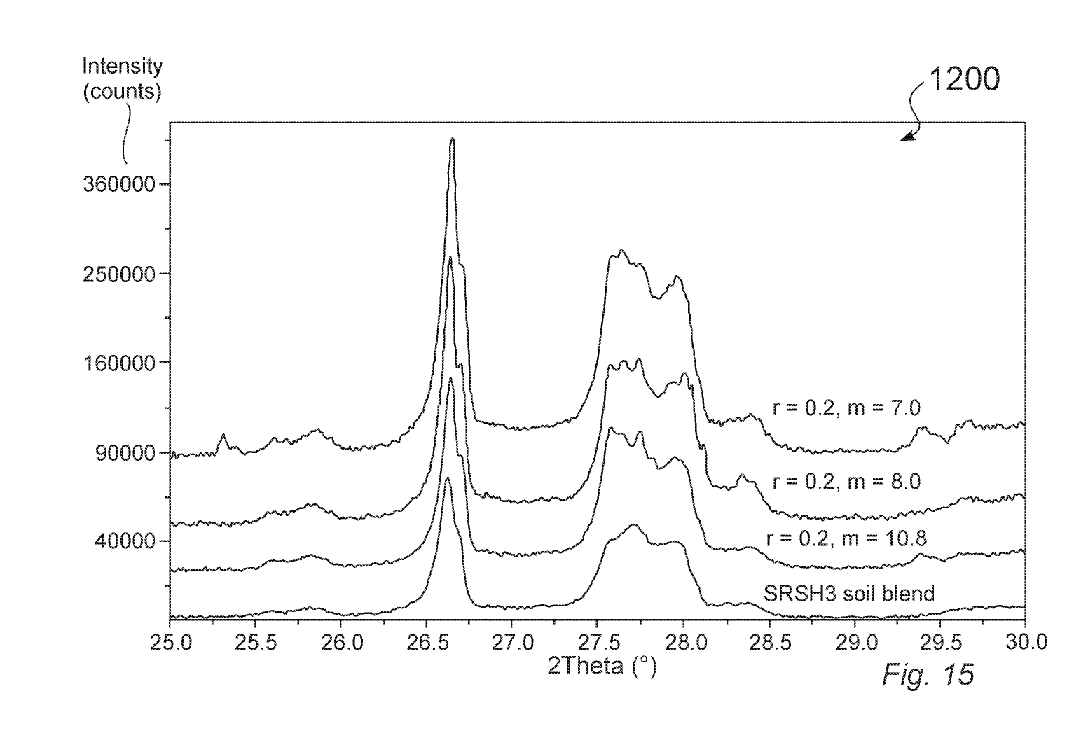

FIG. 15 is a chart 1200 that shows detailed X-ray diffractogram of principal diffraction peaks of alkali feldspar between 27.0 and 28.5 2θ. As illustrated in FIG. 15, the presence of the NaOH alkali activators also caused a change in the relative intensities of the diffraction peaks located between 27.0 and 28.5 2θ. This region of peaks corresponded to diffraction of alkali feldspar. Peaks at 27.59, 27.65 and 28.04 2θ increased, while peak at 27.71 2θ diminished, implying that the alkalis induced a partial dissolution of the alkali feldspar.

Seeding Effect of Mineral Additives and Synthetic Nanoaluminosilicate.

The XRD results confirmed that the alkali activation of the SRSH3 soil blend was limited by the poor solubility of the natural aluminosilicate minerals, principally the feldspars. This observation is in agreement with previous research performed in alkali activated kaolin/feldspar binary systems. One strategy used to overcome this limitation was to promote the nucleation of aluminum- and silicon-oxide polymers in the geopolymerization reaction. The addition of nanosized minerals, which can act as nuclei centers, has been shown to be an effective strategy for enhancing the geopolymerization reaction in soils with low proportions of highly-reactive aluminosilicates. The main goal of these experiments was to understand the effects of various nanoparticle-sized minerals on the geopolymerization reaction in the SRSH3 mix design. A total of five different types of minerals were tested: one calcium carbonate, one feldspar, one 2:1 phyllosilicate (bentonite) and two 1:1 phyllosilicates (kaolin and halloysite).

FIG. 8 is a chart 500 that shows size distribution of mineral additives measured using a laser particle size analyzer. Even though these materials can be characterized as nanoparticle additives, the particle-size distribution measurements obtained through laser diffraction spectrometry, presented in FIG. 8, show a high degree of agglomeration of these materials. Thus, when initially added to the feedstock 130, such as within a primary mixer 12, the additives are not typically fully dispersed, wherein their nucleation capacity can be significantly diminished.

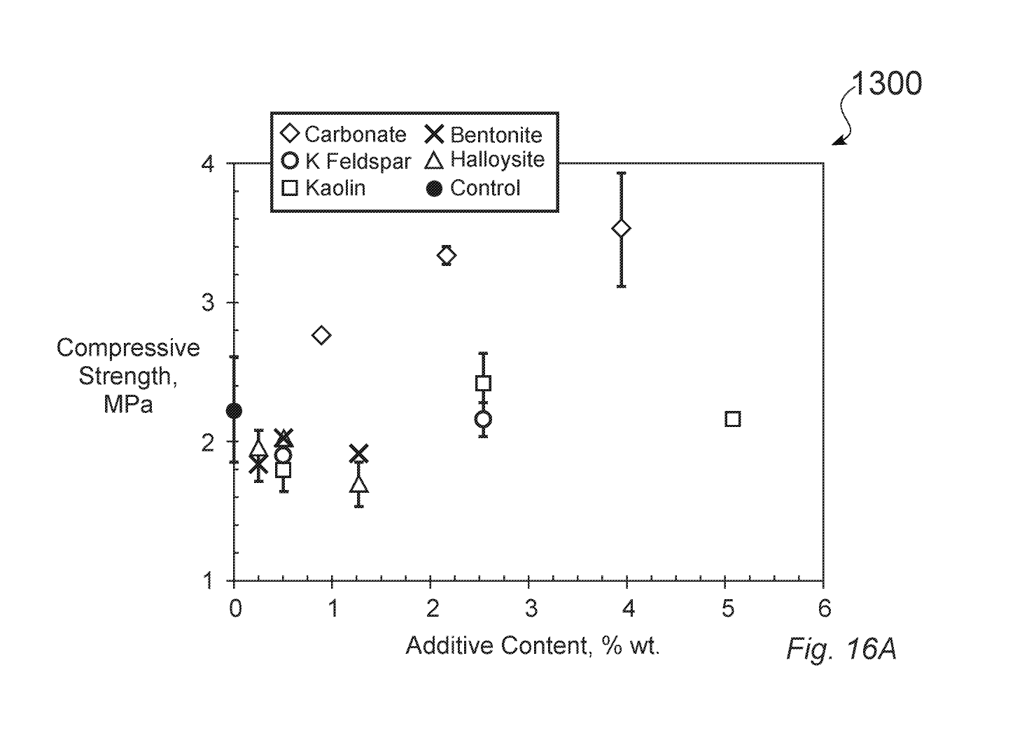

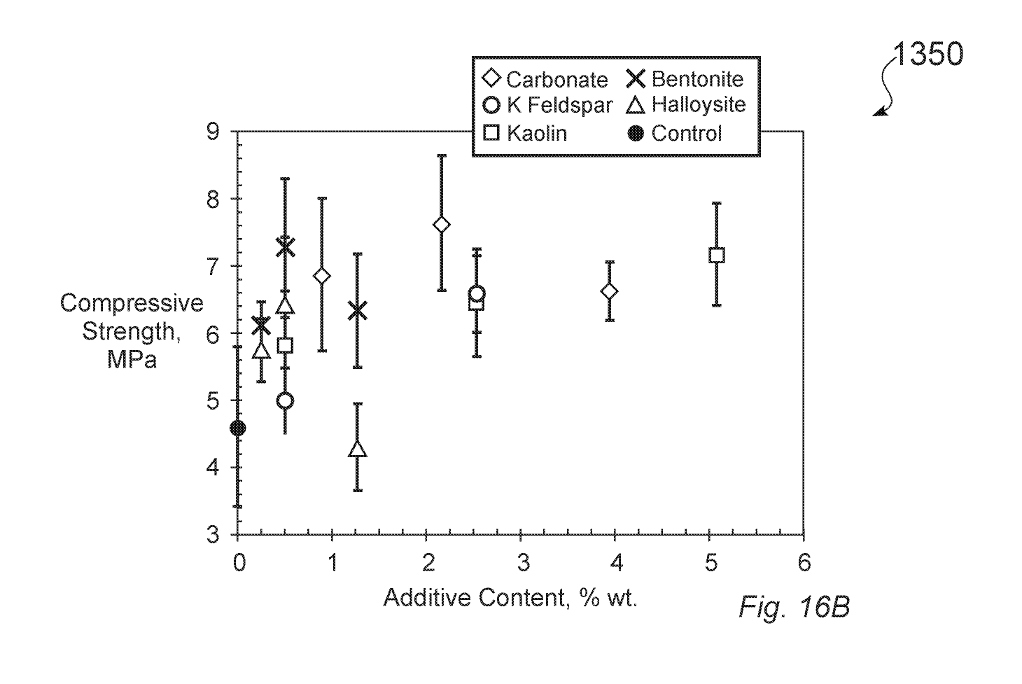

The percentage of mineral additives tested ranged from a minimum of 0.2 wt. % to a maximum of 5.0 wt. %, as illustrated in FIGS. 16A and 16B. At the dosage levels tested, the minerals contributed to an increase in 7-day compressive strength (FIG. 16B). The types of minerals tested have been shown to react slowly under alkaline conditions, which likely explains why strength gains were not pronounced at 1 day but were at 7 days. The calcium carbonate proved an exception to this behavior of slow reactivity, its addition inducing significantly higher 1-day compressive strengths. This can be explained by two factors:
its finer particle-size distribution in comparison to the other mineral additives tested; and
its unique reactivity in alkali environments.

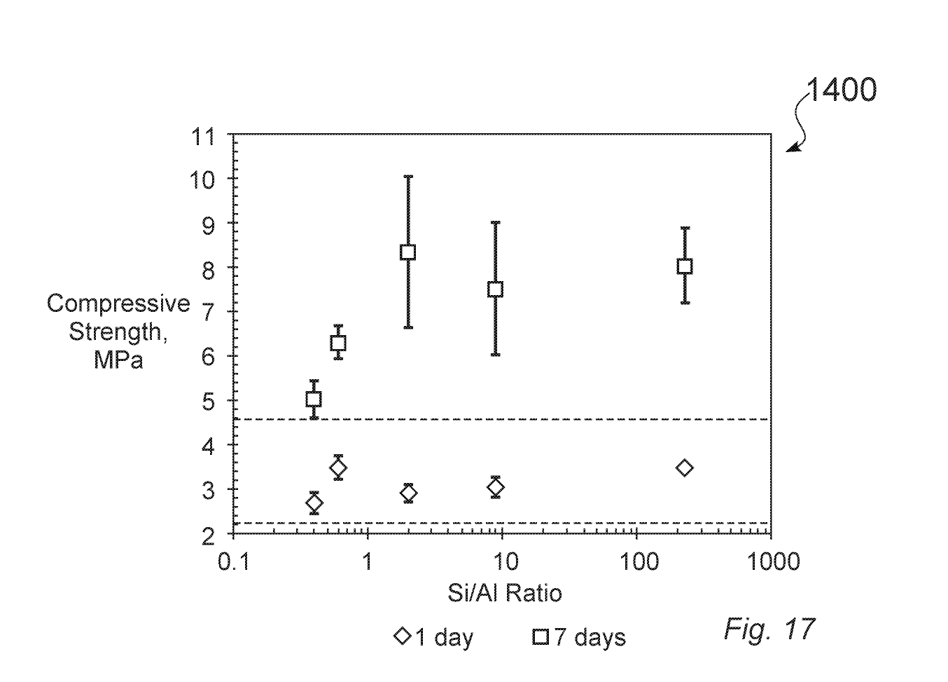

FIG. 17 is a graph 1400 showing a correlation between silicon to aluminum ratio of the nanoparticle additives and compressive strength of soil specimens stabilized using NaOH/sodium silicate with r=0.2, m=0.22 and w/g=0.5 at 1 day and 7 days, wherein the strength values of the control at 1 day (2.23 MPa) and 7 days (4.61 MPa) are included for comparison purposes. The capacity of the tested mineral additives to act as nuclei seeds (thereby enhancing geopolymerization) was compared against that of amorphous nanoaluminosilicate additives. These amorphous nanoaluminosilicates had a strong seeding effect on the geopolymerization reaction as evidenced by their effects on 1 day and 7 day compressive strength at concentrations as low as 0.25% by wt., as shown in FIG. 17.

One or more mechanisms can be responsible for increases in compressive strength. For example, that nanoaluminosilicates may incorporate Na+ in the pore solution from the alkali activator to produce sodium aluminosilicate hydrate gel (N-A-S-H), in a way similar to that in which clay minerals can react with NaOH. These early-formed N-A-S-H nanoparticles can act as nuclei seeds for further growth of this gel inside the stabilized soil system. At later stages in the curing process, the aluminum and silica necessary for the continuous growth of the N-A-S-H gel can be supplied by the alkaline dissolution of different aluminosilicate minerals within the soil-based feedstock 130,170.

The compressive strength of specimens produced from mix designs containing amorphous nanoaluminosilicates was related to the silicon to aluminum ratios (Si/Al) of the different nanoaluminosilicates. The most significant increase in 1-day compressive strength (56% increase over the control) was rendered by mix designs incorporating nanoaluminosilicates with a Si/Al ratio of 0.6 (60_AT). The most significant increase in 7-day compressive strength (80% increase over the control) was rendered by mix designs incorporating nanoaluminosilicates with a Si/Al ratio of 2 (20_AT). The fact that the optimal Si/Al ratio varied with respect to 1-day and 7-day compressive strengths may be explained by variable capacities of these different nanoparticles to absorb cations from alkaline pore solution. Under these conditions, the absorption of sodium by the nanoaluminosilicates with a Si/Al ratio of 2 (20_AT) occurred more slowly than it did for those with a Si/Al ratio of 0.6 (60_AT). According to the results in ordinary Portland cement paste samples, the following hypothesis could be formulated to explain the behavior observed in the alkali-activated soils: the speed with which nanoaluminosilicates produce N-A-S-H seeds is proportional to their capacity to incorporate sodium from the pore solution. Thus, the nanoaluminosilicates with a 0.6 Si/Al ratio (60_AT) will produce faster N-A-S-H seeds than the nanoaluminosilicates with a Si/Al ratio of 2 (20_AT). A faster nucleation of N-A-S-H will translate into more significant early compressive strength development. This hypothesis may be further confirmed by detailed investigations of the ion concentrations in stabilized-soil pore solutions and the chemistry of the new hydration gels nucleated. Based on their effects on longer-term strength development, the synthetic nanoaluminosilicates with a Si/Al ratio of 2 were selected for further study.

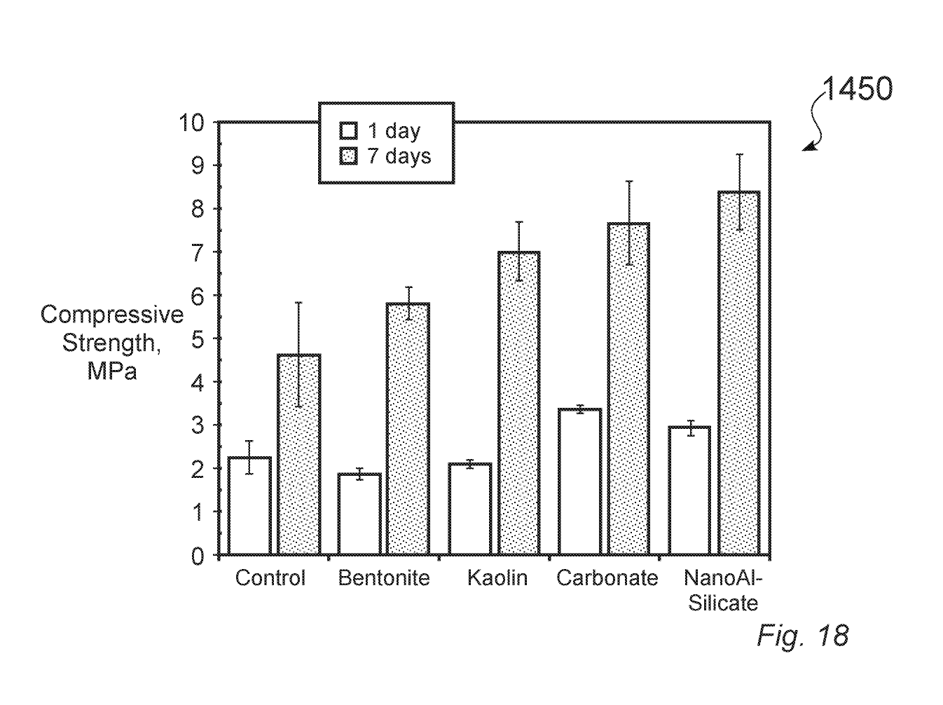

FIG. 18 is a chart 1450 that shows the influence of different nanoaluminosilicate additives on 1-day and 7-day compressive strength of test specimens, wherein the specimens were stabilized using NaOH/sodium silicate with r=0.2, m=0.22 and w/g=0.5. As seen in FIG. 18, a comparison between the synthetic amorphous nanoaluminosilicates and the natural nanoparticle additives described previously reveals the strong seeding capacity of the former. The synthetic nanoaluminosilicates with a Si/Al ratio of 2 (20_AT) and the calcium carbonate had similar effects on 1-day and 7-day compressive strength, but with dosages of the synthetic nanoaluminosilicates being one order of magnitude less. The superior performance of the synthetic nanoaluminosilicates can be explained by their higher reactivity in comparison to the other nanoparticle additives due to:

their amorphous character; and

the degree of agglomeration.

Comparative Analysis of Microstructure of the Optimized Soil Mix Design.

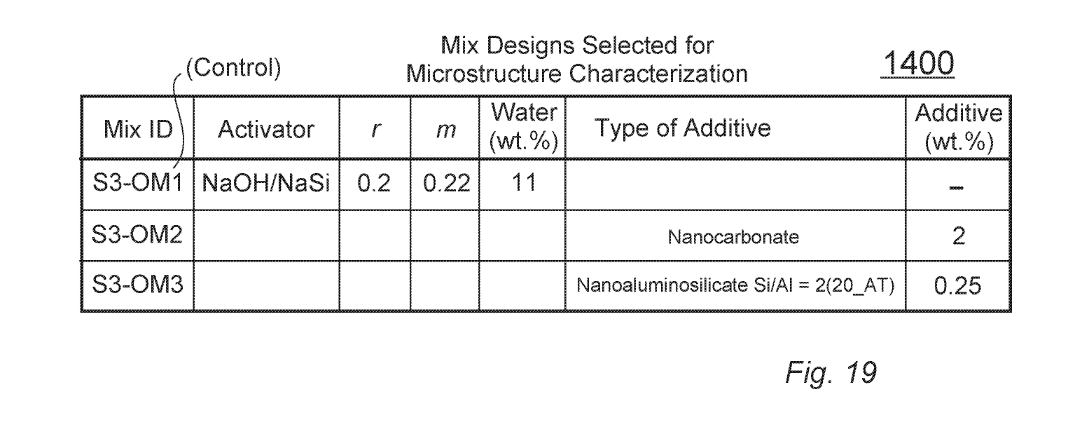

The microstructures of the two most effective additives tested (calcium carbonate, and the synthetic nanoaluminosilicates with a Si/Al ratio of 2 (20_AT) were further characterized. The following properties of test specimens were studied to find correlations between porosity and the seeding effect demonstrated by these additives: absorption, capillary absorption rate (sorptivity) and pore-size distribution. A summary of the mix designs used to produce test specimens in these experiments is given in the table 1400 shown in FIG. 19.

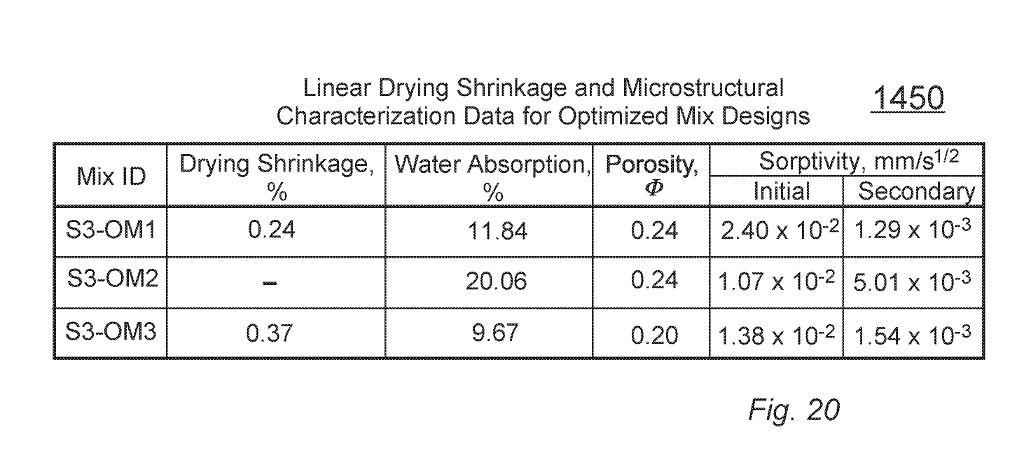

Results from linear drying shrinkage, water absorption and sorptivity are summarized in the table 1450 shown in FIG. 20. The volume fraction of pores (φ) was calculated using water absorption values, based on an equation proposed by Jackson and Dhir. A problem was encountered with the mix containing nanocarbonates (S3-OM2); the immersion of these specimens in water for 48 h prior to linear drying shrinkage measurements weakened them significantly, rendering every attempt at linear drying shrinkage testing via ASTMC426-10 impracticable. It is plausible that the loss in strength experienced upon saturation was motivated by the dissolution of newly formed water soluble carbonate phase, a mineral formed upon contact of the nanocarbonates with sodium from the alkali-activator (XRD diffraction in S3-OM2 specimens prior and after 48 h immersion in water did not allow for the confirmation of this hypothesis, as the main peaks of sodium carbonate minerals were hidden due to the presence of feldspars). The decomposition of this mineral in the presence of water significantly influenced the water absorption and sorptivity of test specimens cast with the nanocarbonate additive as well.

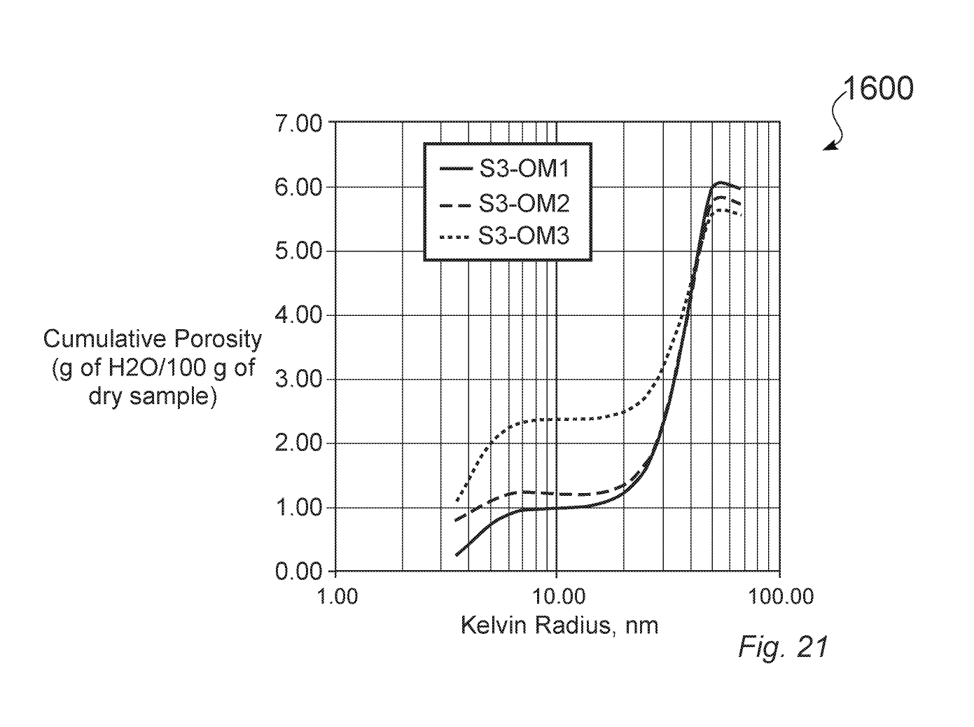

Linear drying shrinkage was correlated with U, as well as their size-distribution. In general, lesser U values and more refined pore-size distributions (fewer coarse pores and more fine pores) were linked to higher linear drying shrinkage values. An example of this correlation was illustrated by the S3-OM3 mix design; the addition of nanoaluminosilicates caused a reduction in overall porosity (Table 4—FIG. 20) as well as a refinement in the pore-size distribution (FIG. 21). This was due to the relatively high nucleation capacity of these synthetic nanoaluminosilicates, which contributed to the formation of a greater volume of hydration gels, capable of filling a more pore-spaces. Sorptivity results also indicated that S3-OM3 experienced lower initial rates of absorption, relative to the control (S3-OM1); therefore, the addition of nanoaluminosilicates also promoted a higher degree of de-percolation of the pore network. The mix containing nanocarbonates (S3-OM2), yielded the lowest initial sorptivity (caused by the high initial nucleation capacity of this additive, resulting in a refined and highly de-percolated pore structure), however, the progressive collapse of the newly formed water soluble carbonate phase in these specimens rendered the highest secondary rate of absorption measured in these experiments.

The data presented in this research work demonstrates the feasibility of using common, naturally-occurring aluminosilicate minerals found in soils and quarry by-products, together with alkali-activators, to produce stabilized earth materials with reliable mechanical performance characteristics in the absence of traditional cement binders.

For example. the experimental SRSH3 soil blend was successfully stabilized with an alkali activator consisting of a combination of NaOH and NaSi (having an r-value of 0.2, an m-value of 0.22) following appropriate manufacturing conditions (including use of high-pressure hydraulic compression, a molding moisture content of 11 wt. %, and a curing regime of 7 days at 65 degrees C.). The implementation of these conditions precipitated the production of test specimens with compressive strengths of 7.58 MPa (1100 psi). XRD analysis of specimens produced in these conditions showed the disappearance of low-angle peaks of montmorillonite at 5.76 2θ. The alkaline cations promoted the exfoliation of the montmorillonite particles, which increased the specific surface of the clay, facilitating its dissolution under alkaline conditions to promote geopolymerization. In addition, XRD analysis also showed changes in the diffraction peaks of the alkaline feldspars located between 27.0 28.5 2θ, indicating their contribution to the geopolymerization reaction.

Nuclei-seeding was revealed as a valid strategy to further enhance the geopolymerization reaction in compressed earth systems utilizing poorly-reactive, natural aluminosilicates. Naturally-occurring, crystalline nanoparticles (such as nanocarbonates, feldspars and clay minerals) as well as synthetic amorphous nanoaluminosilicates, showed strong capacities to act as nuclei seeds and enhance geopolymerization. The addition of 4 wt. % of calcite and 0.25 wt. % of amorphous synthetic nanoaluminosilicate (Si/Al=2) rendered 60% and 80% increases in compressive strength (relative to the control), respectively.

A more in-depth characterization of test specimens illuminated certain correlations between mechanical performance and characteristics of the various materials' microstructures. Significantly, specimens containing nanoaluminosilicates showed reduced volume fractions of pores, more refined pore structures (fewer coarse pores and more fine pores) and more de-percolated pore structures in comparison to the control group. These changes in pore characteristics translated into higher linear drying shrinkage values and reduced sorptivity.

The feasibility of achieving geopolymerization in alkaliactivated soils represents a significant finding, as it represents a means of producing strong masonry materials not only in the absence of OPC, but in the absence of supplemental cementitious materials or highly reactive aluminosilicates (e.g., fly-ash), using virtually inexhaustible and widely-occurring resources.

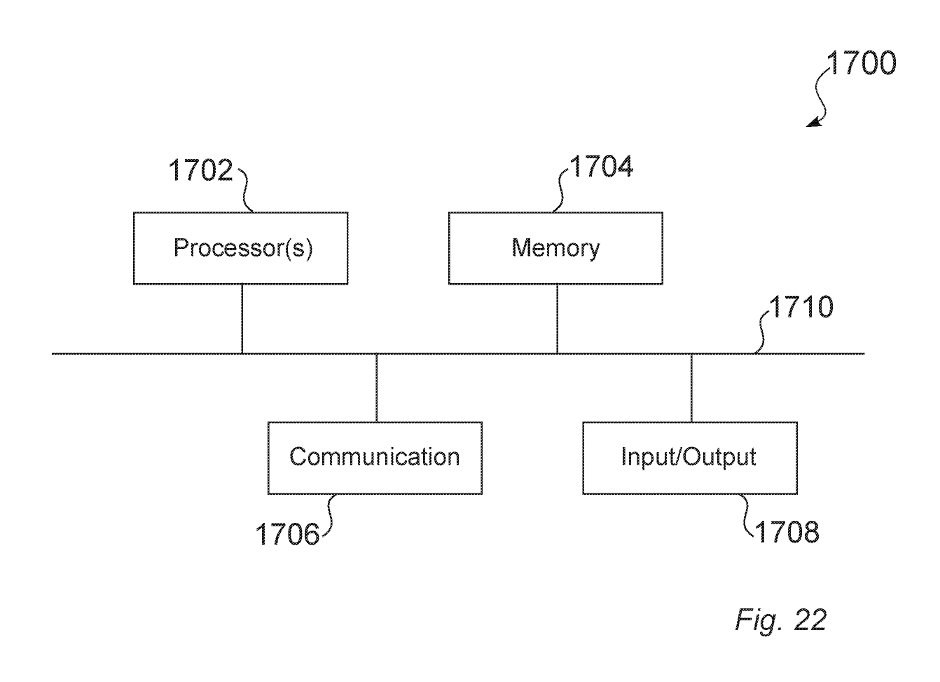

FIG. 22 is a high level block diagram showing an illustrative processing device 1700 that can be a part of any of the systems described above, such as for the pre-mixing controller 14, the high-shear mixer controller 20, the block press controller 26, a curing controller 36, other local controllers, or a system controller 34 for manufacturing the enhanced masonry blocks or other products 28. Any of these systems can be or include two or more processing devices such as represented in FIG. 22, which can be coupled to each other via a network or multiple networks.

In the illustrated embodiment, the processing system 1700 includes one or more processors 1702, memory 1704, a communication device 1706, and one or more input/output (I/O) devices 1708, all coupled to each other through an interconnect 1710. The interconnect 1710 may be or include one or more conductive traces, buses, point-to-point connections, controllers, adapters and/or other conventional connection devices. The processor(s) 1702 may be or include, for example, one or more general-purpose programmable microprocessors, microcontrollers, application specific integrated circuits (ASICs), programmable gate arrays, or the like, or a combination of such devices. The processor(s) 1702 control the overall operation of the processing device 1700. Memory 1704 may be or include one or more physical storage devices, which may be in the form of random access memory (RAM), read-only memory (ROM) (which may be erasable and programmable), flash memory, miniature hard disk drive, or other suitable type of storage device, or a combination of such devices. Memory 1704 may store data and instructions that configure the processor(s) 1702 to execute operations in accordance with the techniques described above. The communication device 1706 may be or include, for example, an Ethernet adapter, cable modem, Wi-Fi adapter, cellular transceiver, Bluetooth transceiver, or the like, or a combination thereof. Depending on the specific nature and purpose of the processing device 1700, the I/O devices 1708 can include devices such as a display (which may be a touch screen display), audio speaker, keyboard, mouse or other pointing device, microphone, camera, etc.

The enhanced masonry manufacturing system 10 and associated methods can readily be scaled for a wide variety of work environments. For example, enhanced masonry manufacturing system 10 can include any number of primary mixers 12, secondary mixers 18, hoppers 844, high-compression block presses 24, post-production finishing stations 31, curing areas 32, or any combination thereof. As well, the high-compression block press 24 can be configured to fabricate one or more enhanced masonry blocks 28. Furthermore, the specific hardware and stations can be used independently. In addition, the specific hardware and stations can readily be moved and transported, such as to provide in situ fabrication of enhanced masonry units, blocks, or other masonry products, wherein locally available materials can be used as constituents within pre-moistened masonry formula 130 and product formula 170.

Unless contrary to physical possibility, it is envisioned that (i) the methods/steps described above may be performed in any sequence and/or in any combination, and that (ii) the components of respective embodiments may be combined in any manner.

The mixing and/or masonry product manufacturing techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, or any device with one or more processors, etc.). For example, a machine-accessible medium includes recordable/non-recordable media, e.g., a non-transitory medium, read-only memory (ROM); random access memory (RAM); magnetic disk storage media; optical storage media; flash memory devices; etc.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification, drawings, and attached appendices are to be regarded in an illustrative sense rather than a restrictive sense.

1. A method, comprising:
premixing a moistened masonry formula, wherein the moistened masonry formula includes an aggregate, a natural aluminosilicate material, an alkali activator, and water;
processing the moistened masonry formula in a secondary mixer to produce masonry product formula, wherein the processing includes at least one of:
breaking apart agglomerations in the moistened masonry formula,
pulverizing the moistened masonry formula,
enhancing dispersion of the moistened masonry formula, and
enhancing homogeneity of the moistened masonry formula;
filling a block mold with the processed masonry product formula; and
applying compression of the masonry product formula within in the block mold to form a masonry block.

2. The method of claim 1, wherein the applied compression ranges from 1500 to 2500 pounds of force per square inch of unit face.

3. The method of claim 1, wherein the applied compression is based on a predetermined threshold.

4. The method of claim 3, wherein the predetermined threshold based on any of density, volume, reduction of voids, the moistened partially mixed formula, or any combination thereof.

5. The method of claim 1, further comprising:
curing the formed masonry block for a predetermined time, wherein the curing includes at least one of:
dissolution of aluminosilicates through interaction with alkali materials;
condensation of precursor ions into monomers; and
polycondensation or polymerization of monomers into polymeric structures.

6. The method of claim 5, wherein the curing includes at least one of:
maintaining the masonry blocks at a temperature of 60 to 95 degrees C. for a predetermined curing period; and
maintaining the masonry blocks at relative humidity of 80 to 95% for a predetermined curing period.

7. The method of claim 5, wherein the curing is performed for a period of 24 to 72 hours.

8. A masonry feedstock comprising:
an aggregate;
a natural aluminosilicate material;
an alkali activator configured to initiate a geopolymer reaction with the natural aluminosilicate material; and
water.

9. The masonry feedstock of claim 8, wherein the aggregate includes one or more aggregates from a region wherein the masonry feedstock is produced.

10. The masonry feedstock of claim 8, wherein the aggregate accounts for 50 percent to 75 percent by weight of the masonry feedstock.

11. The masonry feedstock of claim 8, wherein the natural aluminosilicate material includes any of clay minerals and feldspars.

12. The masonry feedstock of claim 8, wherein the natural aluminosilicate material accounts for 15 percent to 35 percent by weight of the masonry feedstock.

13. The masonry feedstock of claim 8, wherein the alkali activator accounts for 3 percent to 5 percent by weight of the masonry feedstock.

14. The masonry feedstock of claim 8, wherein the alkali activator includes any of sodium silicate and sodium hydroxide.

15. The masonry feedstock of claim 8, wherein the water accounts for 5 percent to 10 percent by weight of the masonry feedstock.

16. The masonry feedstock of claim 8, wherein the masonry formula further includes a constituent other than the aggregate, the natural aluminosilicate material, the alkali activator, and the water.

17. The masonry feedstock of claim 16, wherein the constituent is any of hydrated lime, a supplementary cementitious material (SCM), a water repelling additive, a nano-seeding additive, or any combination thereof.

18. A method for preparing a masonry product formula, comprising:
mixing together a moistened masonry formula in a primary mixer, wherein the moistened masonry formula includes an aggregate, a natural aluminosilicate material, an alkali activator, and water;
processing the moistened masonry formula in a secondary mixer to produce masonry product formula, wherein the processing includes any of:
breaking apart agglomerations in the moistened masonry formula,
pulverizing the moistened masonry formula,
enhancing dispersion of the moistened masonry formula, and
enhancing homogeneity of the moistened masonry formula;
outputting the masonry product formula.

19. The method of claim 18, wherein the masonry formula further includes a constituent other than the aggregate, the natural aluminosilicate material, the alkali activator, and the water.

20. The method of claim 19, wherein the constituent is any of hydrated lime, a supplementary cementitious material (SCM), a water repelling additive, a nano-seeding additive, or any combination thereof.

21. The method of claim 18, wherein the processing the moistened masonry formula in a secondary mixer to produce masonry product formula comprises:
rotating a downwardly facing mixing assembly within a mixing chamber having an upper end and a lower end opposite the upper end, wherein the mixing assembly includes a rotating mixer shaft having mixing tools attached thereto;
dropping the moistened masonry formula downwardly through the mixing chamber past the mixing tools;
processing the moistened masonry formula with the mixing tools to produce the masonry product formula; and
collecting the masonry product formula as the product formula exits the lower end of the mixing chamber.
